(19) United States
(12) Patent Application Publication
(10) Pub. No.: US 2026/0239063 A1
(43) Pub. Date: Aug. 13, 2026

(54) FLEXIBLE EVENT CONFIGURATION

(71) Applicant: QUALCOMM Incorporated, San Diego, CA (US)

(72) Inventors: Sony AKKARAKARAN, Poway, CA (US); Kiran VENUGOPAL, Green Brook, NJ (US); Navid ABEDINI, Basking Ridge, NJ (US); Tao LUO, San Diego, CA (US); Junyi LI, Greentown, PA (US)

(21) Appl. No.: 19/052,464

(22) Filed: Feb. 13, 2025

(51) Int. Cl. H04W 24/10

(52) U.S. Cl. CPC H04W 24/10

(57) ABSTRACT

Methods, systems, and devices for wireless communications are described. A user equipment (UE) may report its capability to read (e.g., parse), or execute custom events. The UE may indicate what type or how much information related to custom events it can read or utilize based on its processing capability. The network may configure the UE with a list of custom events, and each custom event may be defined by a set of conditions corresponding to the event. The conditions may include parameters specific to the custom events, such as measurements, entry and exit conditions, variable state parameters, or the like. If the UE determines that the conditions for a given custom event are satisfied (e.g., based on performing any measurements or determinations in accordance with the parameters of that event), the UE may transmit a report to the network.

### FIELD OF TECHNOLOGY

The following relates to wireless communications, including flexible event configuration.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting a capability information message indicating that the UE is capable of reading an indication of at least one dynamically configured event, detecting whether conditions corresponding to the at least one dynamically configured event are satisfied, or both, receiving a radio resource control message including a list of dynamically configured events, each dynamically configured event corresponding to a set of multiple parameters, where each dynamically configured event is based on the capability information message, receiving a control message indicating one or more parameters for reporting an occurrence of at least a first event of the list of dynamically configured events, and transmitting a report message indicating the occurrence of the first event based on detecting that one or more conditions corresponding to the first event are satisfied.

A UE for wireless communications is described. The UE may include one or more memories storing processor executable code, and one or more processors coupled with the one or more memories. The one or more processors may individually or collectively be operable to execute the code to cause the UE to transmit a capability information message indicating that the UE is capable of reading an indication of at least one dynamically configured event, detecting whether conditions corresponding to the at least one dynamically configured event are satisfied, or both, receive a radio resource control message including a list of dynamically configured events, each dynamically configured event corresponding to a set of multiple parameters, where each dynamically configured event is based on the capability information message, receive a control message indicating one or more parameters for reporting an occurrence of at least a first event of the list of dynamically configured events, and transmit a report message indicating the occurrence of the first event based on detecting that one or more conditions corresponding to the first event are satisfied.

Another UE for wireless communications is described. The UE may include means for transmitting a capability information message indicating that the UE is capable of reading an indication of at least one dynamically configured event, detecting whether conditions corresponding to the at least one dynamically configured event are satisfied, or both, means for receiving a radio resource control message including a list of dynamically configured events, each dynamically configured event corresponding to a set of multiple parameters, where each dynamically configured event is based on the capability information message, means for receiving a control message indicating one or more parameters for reporting an occurrence of at least a first event of the list of dynamically configured events, and means for transmitting a report message indicating the occurrence of the first event based on detecting that one or more conditions corresponding to the first event are satisfied.

A non-transitory computer-readable medium storing code for wireless communications is described. The code may include instructions executable by one or more processors to transmit a capability information message indicating that the UE is capable of reading an indication of at least one dynamically configured event, detecting whether conditions corresponding to the at least one dynamically configured event are satisfied, or both, receive a radio resource control message including a list of dynamically configured events, each dynamically configured event corresponding to a set of multiple parameters, where each dynamically configured event is based on the capability information message, receive a control message indicating one or more parameters for reporting an occurrence of at least a first event of the list of dynamically configured events, and transmit a report message indicating the occurrence of the first event based on detecting that one or more conditions corresponding to the first event are satisfied.

In some examples of the method, UEs, and non-transitory computer-readable medium described herein, the capability information message includes an indication of a threshold quantity of events of the list of dynamically configured events, a set of combinations of a set of multiple conditions the UE may be capable of monitoring, a threshold quantity of information in the list of dynamically configured events, a threshold quantity of conditions corresponding to each event of the list of dynamically configured events, a dependency depth for each event of the list of dynamically configured events, or any combination thereof.

In some examples of the method, UEs, and non-transitory computer-readable medium described herein, detecting that one or more conditions corresponding to the first event may be satisfied may include operations, features, means, or instructions for performing one or more measurements on one or more received signals and determining that the one or more measurements satisfy the one or more conditions.

In some examples of the method, UEs, and non-transitory computer-readable medium described herein, the one or more parameters corresponding to the first event includes an identifier of the one or more received signals, a frequency occupancy of the one or more received signals, a channel identifier corresponding to the one or more parameters, a time stamp corresponding to the one or more received signals, a measurement quantity corresponding to the one or more measurements, a time duration corresponding to the one or more measurements, a measurement identifier corresponding to the one or more measurements, or any combination thereof.

In some examples of the method, UEs, and non-transitory computer-readable medium described herein, detecting that one or more conditions corresponding to the first event may be satisfied may include operations, features, means, or instructions for determining that a location, speed, direction, device type, or cell identifier satisfy the one or more conditions and performing one or more measurements on one or more received signals based on the one or more conditions being satisfied.

In some examples of the method, UEs, and non-transitory computer-readable medium described herein, the one or more parameters corresponding to the first event includes an index value corresponding to the one or more parameters, each index value of a set of index values including the first event corresponds to a respective candidate set of parameters.

In some examples of the method, UEs, and non-transitory computer-readable medium described herein, detecting that one or more conditions corresponding to the first event may be satisfied may include operations, features, means, or instructions for detecting that a state variable may have changed, the state variable including expiration of a timer, a counter value satisfying a threshold, a connection state, a location of the UE, or any combination thereof.

In some examples of the method, UEs, and non-transitory computer-readable medium described herein, the set of multiple parameters corresponding to the first event includes a range of values defined by a set of measurements, a set of operators, a table, or a combination thereof and detecting that the one or more conditions may be satisfied includes determining that a measured value or detected state falls within the range of values.

In some examples of the method, UEs, and non-transitory computer-readable medium described herein, the set of multiple parameters corresponding to the first event includes a subset of values of a vector and detecting that the one or more conditions may be satisfied includes determining that a set of measured values or detected states may be defined within the subset of values.

A method for wireless communications by a network entity is described. The method may include receiving a capability information message indicating that a UE is capable of reading an indication of at least one dynamically configured event, detecting whether conditions corresponding to the at least one dynamically configured event are satisfied, or both, transmitting a radio resource control message including a list of dynamically configured events, each dynamically configured event corresponding to a set of multiple parameters, where each dynamically configured event is based on the capability information message, transmitting a control message indicating one or more parameters for reporting an occurrence of at least a first event of the list of dynamically configured events, and receiving a report message indicating the occurrence of the first event associated with one or more conditions corresponding to the first event being satisfied.

A network entity for wireless communications is described. The network entity may include one or more memories storing processor executable code, and one or more processors coupled with the one or more memories. The one or more processors may individually or collectively be operable to execute the code to cause the network entity to receive a capability information message indicating that a UE is capable of reading an indication of at least one dynamically configured event, detecting whether conditions corresponding to the at least one dynamically configured event are satisfied, or both, transmit a radio resource control message including a list of dynamically configured events, each dynamically configured event corresponding to a set of multiple parameters, where each dynamically configured event is based on the capability information message, transmit a control message indicating one or more parameters for reporting an occurrence of at least a first event of the list of dynamically configured events, and receive a report message indicating the occurrence of the first event associated with one or more conditions corresponding to the first event being satisfied.

Another network entity for wireless communications is described. The network entity may include means for receiving a capability information message indicating that a UE is capable of reading an indication of at least one dynamically configured event, detecting whether conditions corresponding to the at least one dynamically configured event are satisfied, or both, means for transmitting a radio resource control message including a list of dynamically configured events, each dynamically configured event corresponding to a set of multiple parameters, where each dynamically configured event is based on the capability information message, means for transmitting a control message indicating one or more parameters for reporting an occurrence of at least a first event of the list of dynamically configured events, and means for receiving a report message indicating the occurrence of the first event associated with one or more conditions corresponding to the first event being satisfied.

A non-transitory computer-readable medium storing code for wireless communications is described. The code may include instructions executable by one or more processors to receive a capability information message indicating that a UE is capable of reading an indication of at least one dynamically configured event, detecting whether conditions corresponding to the at least one dynamically configured event are satisfied, or both, transmit a radio resource control message including a list of dynamically configured events, each dynamically configured event corresponding to a set of multiple parameters, where each dynamically configured event is based on the capability information message, transmit a control message indicating one or more parameters for reporting an occurrence of at least a first event of the list of dynamically configured events, and receive a report message indicating the occurrence of the first event associated with one or more conditions corresponding to the first event being satisfied.

In some examples of the method, network entities, and non-transitory computer-readable medium described herein, the capability information message includes an indication of a threshold quantity of events of the list of dynamically configured events, a set of combinations of a set of multiple conditions the UE may be capable of monitoring, a threshold quantity of information in the list of dynamically configured events, a threshold quantity of conditions corresponding to each event of the list of dynamically configured events, a dependency depth for each event of the list of dynamically configured events, or any combination thereof.

In some examples of the method, network entities, and non-transitory computer-readable medium described herein, the one or more parameters corresponding to the first event includes an identifier of the one or more received signals, a frequency occupancy of the one or more received signals, a channel identifier corresponding to the one or more parameters, a time stamp corresponding to the one or more received signals, a measurement quantity corresponding to the one or more measurements, a time duration corresponding to the one or more measurements, a measurement identifier corresponding to the one or more measurements, or any combination thereof.

In some examples of the method, network entities, and non-transitory computer-readable medium described herein, the one or more parameters corresponding to the first event includes an index value corresponding to the one or more parameters, each index value of a set of index values including the first event corresponds to a respective candidate set of parameters.

In some examples of the method, network entities, and non-transitory computer-readable medium described herein, the set of multiple parameters corresponding to the first event includes a range of values defined by a set of measurements, a set of operators, a table, or a combination thereof and detecting that the one or more conditions may be satisfied includes determining that a measured value or detected state falls within the range of values.

In some examples of the method, network entities, and non-transitory computer-readable medium described herein, the set of multiple parameters corresponding to the first event includes a subset of values of a vector and detecting that the one or more conditions may be satisfied includes determining that a set of measured values or detected states may be defined within the subset of values.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports flexible event configuration in accordance with one or more aspects of the present disclosure.

FIG. 2 shows an example of a wireless communications system that supports flexible event configuration in accordance with one or more aspects of the present disclosure.

FIG. 3 shows an example of a process flow that supports flexible event configuration in accordance with one or more aspects of the present disclosure.

FIGS. 4 and 5 show block diagrams of devices that support flexible event configuration in accordance with one or more aspects of the present disclosure.

FIG. 6 shows a block diagram of a communications manager that supports flexible event configuration in accordance with one or more aspects of the present disclosure.

FIG. 7 shows a diagram of a system including a device that supports flexible event configuration in accordance with one or more aspects of the present disclosure.

FIGS. 8 and 9 show block diagrams of devices that support flexible event configuration in accordance with one or more aspects of the present disclosure.

FIG. 10 shows a block diagram of a communications manager that supports flexible event configuration in accordance with one or more aspects of the present disclosure.

FIG. 11 shows a diagram of a system including a device that supports flexible event configuration in accordance with one or more aspects of the present disclosure.

FIGS. 12 through 16 show flowcharts illustrating methods that support flexible event configuration in accordance with one or more aspects of the present disclosure.

### DETAILED DESCRIPTION

In some wireless communications systems, a network entity may configure a user equipment (UE) with one or more events (e.g., static or predefined events). Each event may be defined in one or more standards documents. Such events may include one or more measurements to be performed by the UE. In some examples, the network may configure the UE to perform one or more measurements and then transmit a report regarding the measurements for a given event. Because each event is predefined, such events do not support any flexibility. Although the wireless communications system may support additional signals (e.g., positioning reference signals (PRSs), among other examples), such signaling may not be utilized by any defined events, which may result in inefficiency. Further, some wireless systems (e.g., networks) may benefit from additional reporting. However, some reports may be extremely specific (e.g., a traffic or congestion level at a particular geographic location at a particular time of day, or in a particular connected state, among other examples), and may therefore not be standardized or predefined. Lack of flexibility, or lack of capability to request specific information from the UE, may result in large amounts of information being unavailable to the network (e.g., information that may be relevant to artificial intelligence (AI) or machine learning (ML) models). Without access to such information, the network may be unable to improve AI or ML models, identify problems in the system, or may fail to take advantage of otherwise available improvements to the wireless communications system. Such failure to identify the available information may result in inefficient use of available system resources, less reliable wireless communications systems, decreased throughput, increased system latency, and poor user experience.

Techniques described herein support dynamic configuration of custom events by the network. The UE may report its capability to read (e.g., parse) or execute dynamic or custom events. For example, the UE may indicate what type or how much information related to custom events it can read or utilize based on its processing capability (e.g., the UE may indicate a quantity of conditions, a length of information strings, depth of dependency, etc. that it supports for custom events). The network may configure the UE with a list of custom events, and each custom event may be defined by a set of sub information elements (subIEs) (e.g., conditions corresponding to the event). The conditions may include parameters specific to the custom events, such as measurements, entry and exit conditions, variable state parameters, or the like. In some examples, the network entity may also transmit reporting configuration information which may indicate or trigger reporting for one or more of the custom objects. The UE may take one or more actions based on the events or the triggering (e.g., activation) of the events, such as detecting one or more conditions or states, or performing one or more measurements. If the conditions for a given custom event are satisfied (e.g., based on the measurements, or the states, or a combination of conditions, etc.), the UE may transmit a report (e.g., or take another action corresponding to or defined by the custom event). The framework for configuring and reporting custom events described herein may allow for the network to identify and configure any events (e.g., to gather any information) without reliance on pre-configuration of all possible events. Techniques described herein may result in improved flow of information and improved efficiency in wireless communications systems, improved throughput, more efficient use of available system resources, more efficient use of processing resources, decreased system latency, and improved user experience.

Aspects of the disclosure are initially described in the context of wireless communications systems and process flows. Aspects of the disclosure are further illustrated by and described with reference to apparatus diagrams, system diagrams, and flowcharts that relate to flexible event configuration.

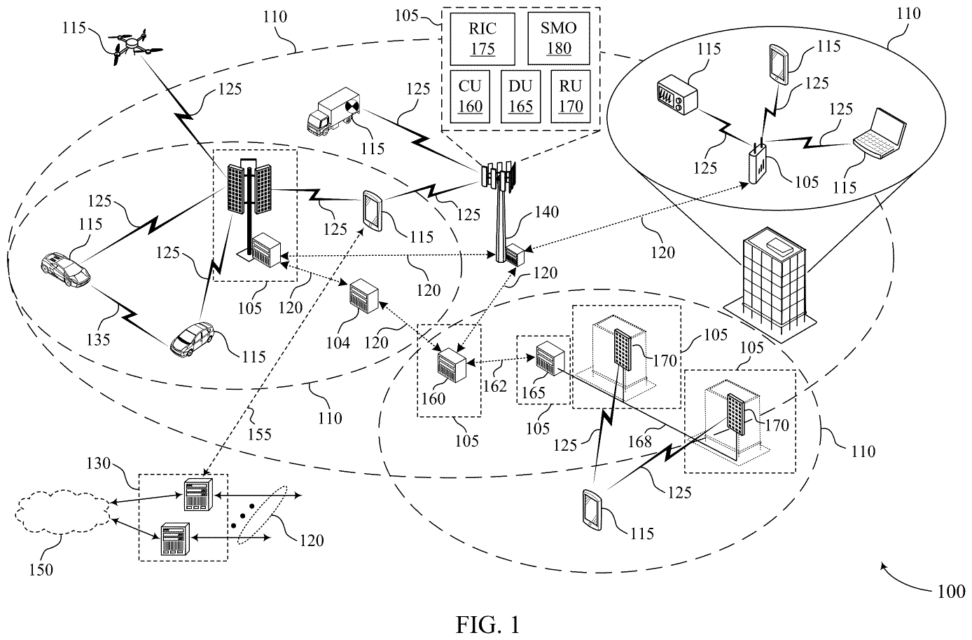

FIG. 1 shows an example of a wireless communications system 100 that supports flexible event configuration in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support flexible event configuration as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ⋅N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Techniques described herein support dynamic configuration of custom events by the network. The UE 115 may report its capability to read (e.g., parse) or execute dynamic or custom events. For example, the UE 115 may indicate what type or how much information related to custom events it can read or utilize based on its processing capability (e.g., the UE 115 may indicate a quantity of conditions, a length of information strings, depth of dependency, etc. that it supports for custom events). The network entity 105 may configure the UE 115 with a list of custom events, and each custom event may be defined by a set of subIEs (e.g., conditions corresponding to the event). The conditions may include parameters specific to the custom events, such as measurements, entry and exit conditions, variable state parameters, or the like. In some examples, the network entity may also transmit reporting configuration information which may indicate or trigger reporting for one or more of the custom objects. The UE 115 may take one or more actions based on the events or the triggering (e.g., activation) of the events, such as detecting one or more conditions or states, or performing one or more measurements. If the conditions for a given custom event are satisfied (e.g., based on the measurements, or the states, or a combination of conditions, etc.), the UE may transmit a report (e.g., or take another action corresponding to or defined by the custom event).

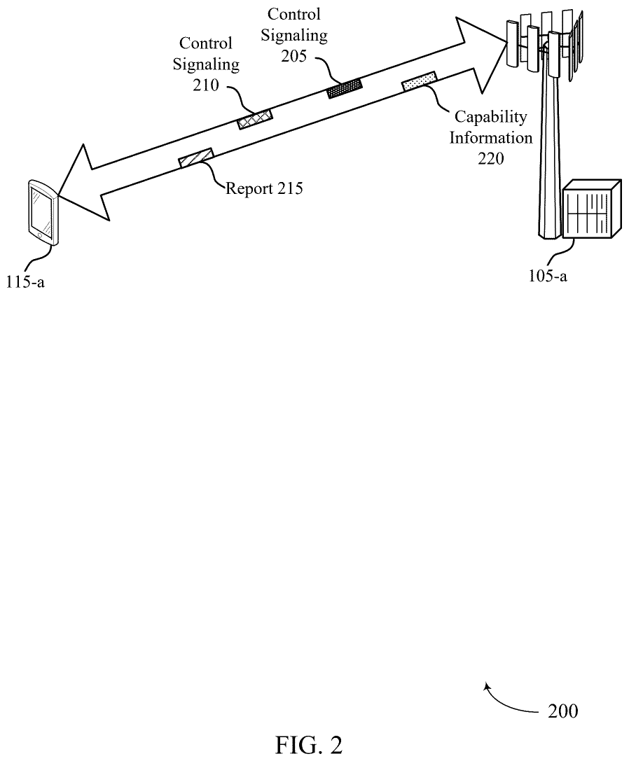

FIG. 2 shows an example of a wireless communications system 200 that supports flexible event configuration in accordance with one or more aspects of the present disclosure. The wireless communications system 200 may implement, or be implemented by, aspects of the wireless communications system 100. For example, the wireless communications system 200 may include a UE 115-a, and a network entity 105-a, which may be examples of corresponding devices described with reference to FIG. 1.

In some cases, the network entity 105-a may configure the UE 115-a with one or more events (e.g., static events). Events may include scenarios, measurements, or actions for the UE 115-a to take. For example, an event may be configured in accordance with a measurement configuration. A measurement configuration may consist of a list of measurement objects (e.g., specifying parameters such as a band, frequency, bandwidth, SMTC, etc., or a measurement timing configuration for performing the measurements). A measurement configuration may consist of a list of report configurations (e.g., specifying parameters such as a type (periodic, event-triggered), a report interval, a report quantity (e.g., reference signal receive power (RSRP), reference signal receive quality (RSRQ), etc.), a report amount, or the like. In cases of event-triggered reporting, the measurement configuration may include a list of triggering events. A measurement configuration may consist of a list of measurement identifiers (measurement IDs), each identifier associated with a measurement object and a report configuration (e.g., indexed into the above lists).

In some examples, each event may be defined explicitly (e.g., in one or more standards documents, or via control signaling, or both). For instance, a first measurement event corresponding to mobility procedures may be defined with an identifier (e.g., as Event A1), and the event corresponding to the event identifier may be defined as a procedure in which the UE 115-a is to report to the network if a serving cell (e.g., corresponding to a network entity 105) becomes better than (e.g., or worse than) a threshold. In such examples, control signaling may indicate or trigger the Event A1, and may configure the UE 115-a to transmit a report message corresponding to the configured Event A1. In such examples, the UE may perform measurements (e.g., RSRP or RSRQ measurements) on one or more signals (e.g., reference signals) in accordance with the configured event. If the measurements for the serving cell satisfy the threshold, then the UE 115-a may transmit a report in accordance with the configuration of the event.

The network entity 105-a may transmit some signaling (e.g., reference signals, such as positioning reference signals (PRSs) which is not utilized in any defined event (e.g., but could be utilized in some cases, despite not being included in the explicit definitions of any static events). In some examples, the network entity 105-a could explicitly configure one or more additional events (e.g., indicating the PRSs for the additional events). However, each additional event would be individually defined (e.g., in one or more standards documents) and then configured at the UE 115-a. Lists of such additionally defined events might be excessively large, resulting in signaling overhead and system latency.

Additionally, or alternatively, some wireless communications may support AI or ML models. In additional to static events (e.g., events defined from RRM scenarios, among other examples), the wireless communications system may benefit from reporting on specific events, rare events (e.g., that do not occur often or periodically), combinations of events, or the like (e.g., which may impact tail performance). Such reports may improve AI or ML model performance (e.g., tail end performance). However, standards documents may not define all possible or candidate events (e.g., reports) that the UE 115-a could provide to the network. Further, configuration of extensive lists of individually defined static events may result in excessive signaling overhead and increased system latency. For instance, the network entity 105-a may benefit from a report indicating performance under specific conditions (e.g., signaling traffic at a specific geographic location, at a specific time of day, given a particular communication state at the UE 115-a, or the like). However, no definition of such a specific report may be defined, rendering such specific reporting impossible. Further, even if such an event were defined, static event definitions may not support any flexibility or change in reporting conditions, triggering events, reported content, or the like. Thus, the network entity 105-a may be limited in the information it can request by predefined static events. As such, AI ML model performance may suffer, and valuable information may be inaccessible to the network entity 105-a, resulting in decreased performance, inefficient use of available system resources, poor performance or unreliability of wireless communications, and poor user experience. Even if additional static events were defined, configuration of and reporting of such additional events may result in increased signaling overhead and increased system latency.

Techniques described herein may support a framework for configuring dynamic (e.g., custom) events. Such dynamic events may be configured using multiple measurements, or combinations of conditions, or the like. Such a framework may support operators or network entities 105 to create events tailored to specific deployments (e.g., without relying on predefined (e.g., standardized) static events or predefined measurement objects). Dynamic events may be defined in accordance with one or more building blocks, as described herein.

In some examples, a custom event may include one or more conditions. Some events may include a condition in which a measurement falls into a certain range (e.g., falls below a threshold ([-inf, T]) or rises above a threshold ([T, inf ,])). Measurements may be configured in accordance with various parameters, which may include frequency, cell identifiers, periodicity, etc. In some examples, the conditions may include more general ranges (e.g., a union of non-overlapping intervals, a range may be defined to include negative or positive infinity, ranges of parameters may be open or closed (e.g., (a, b), [a, b], (a, b] and [a, b), etc.), or the like. Discrete elements may also be part of the framework of dynamic events (e.g., for both discrete and continuous measurements). For example, discrete elements may be represented via a same union of intervals with an interval of a form [a, a], or may have a separate representation as list of points (e.g., {a, b, c}). Measurements may be defined as RSRP, RSRQ, or SINR (e.g., SS-RSRP, SS-RSRQ, SS-SINR), among other examples. Additionally, or alternatively, measurements for dynamic events may include additional measurements (e.g., PRS measurements).

Some dynamic events may be defined with reference to a state variable falling in a certain range. State variables may include a connection state (e.g., an RRC state, such as RRC idle, RRC inactive, RRC connected), a current value of a timer (e.g., running, suspended, not running, expired, actual value of the timer, etc.), or the like. In some examples, a range definition may be configured for continuous states, or a subset of allowed values for discrete states (e.g., RRC states). In some examples, the UE 115-a may be configured to report a current state, or to trigger and report one or more measurements if a state falls within a range or satisfies the conditions of the dynamic event.

Some dynamic events may be defined with reference to a function of multiple measurements, state variables, or the like falling into a range or satisfying a condition. For example, a condition may be whether a difference between RSRP and RSRQ satisfies a threshold (e.g., RSRP-RSRQ>T). Function definitions may use a list of measurements or state variables, as indicated via control signaling (e.g., a combining rules indication, such as an information element (IE)). Such combinations may use combining logic for multiple conditions. In some examples, primitives may be math operators (e.g., instead of or in addition to logical operations such as AND operators, OR operators, etc.). Such primitives (e.g., math operators) may include examples such as +, −, *, exponents, logs, trigonometric functions, derivatives, integrals (of N-th order) with respect to identified variables (e.g. time, position), etc. In some examples, such operators may include functions specified via a table or a software module, which may be downloaded from the configuring node, or from another node.

Some dynamic events may be defined with reference to a vector of measurements (e.g., N measurements that are functions of multiple measurements) that fall within a range or satisfy one or more conditions. The range may refer to a subset of an N-dimensional space, and may or may not be a cartesian product of ranges of individual N dimensions. For example, the range may be described as a union of convex subsets, each subset described as the convex hull of a set of points. For instance, the UE 115-a may perform measurements of x, y, and z coordinates of a UE position. The vector may be defined as [x, y, z] with a range described as a volume or union of volumes in three dimensional space. In some examples, the vector may be defined as a mix of different measurement types (e.g., generalization of UAV-related measurements that involve conditions on signal strength as well as UAV height).

Some dynamic events may be defined with reference to entering and leaving rules, including hysteresis. Some events (e.g., A1: serving cell RSRP (M) exceeds a threshold (T)) may be defined such that an entering and leaving rule include minor variants on the basic condition, parameterized by a single hysteresis value H (e.g., for event A1, M+H>T may define an entering rule, and M-H<T may define a leaving rule). In some examples, a separate H may be configured for each condition. In some cases of dynamic events, a separate entering range and leaving range may be defined for one or more conditions of the dynamic event. For example, if a range=[a, b], then an entering range may be defined as entering range=[a+H1, b−H2], and a leaving range may be defined as leaving range=[a−H3, b+H4]. Such entering and leaving ranges may be generalized to the case of a vector range as described herein, where the range is a subset of N-dimensional space. A special case of no hysteresis may be defined when entering and leaving ranges are identical.

Some dynamic events may be defined as any custom event defined by an event identifier (eventID). The eventID may be unique to the custom event. In some examples, the event ID may refer to one of a list of configured dynamic events, a list of static events, or a list including both dynamic events and static events.

Some dynamic events may be defined using one or more operators (e.g., AND operators, OR operators, NOT operators XOR operators, etc.). In some cases, operators may be utilized to aggregate multiple conditions to define an event. The operators may include Nand operators, or Nor operators (e.g., in which case other operators may be built from the two operators). In some examples, the operators may include AND operators, NOT operators, OR operators XOR operators, XNOR operators, or any combination thereof (e.g., for more compact representation of the logic). A union of intervals may be implemented using logical operators (e.g., OR operators of multiple conditions). Each operator may use a single interval as a primitive. Thus, separate formats for signaling multiple intervals may be avoided. In some examples, different formats may be used for more compact signaling.

In some examples (e.g., option 1), entering or leaving rules may be defined with conditional aggregation. For example, a single common entering or left state may be maintained for all individual conditions as well as an aggregated overall condition. The UE 115-a may perform evaluation of the entering rule for each condition when an overall condition is in the left state. When the overall condition is evaluated as true, the overall state may be changed to entered, at which point the UE 115-a may begin to evaluate the leaving rule for each condition. In some examples (e.g., option 2), the state (e.g., an entered state or a left state) may be separately tracked by the UE 115-a for each constituent condition as well as the overall condition. For each condition, the UE 115-a may evaluate the entering rule if it is in a left state, and may evaluate the leaving rule if the UE 115-a is in the entered state. Then the UE 115-a may update the overall condition state based on the individual condition states, as per the condition-aggregation definition (e.g., with the entered states considered true and the left states considered false). In some examples, the conditions or rules may be grouped (e.g., Option 3, which may refer to a combination of option 1 and option 2). Option 1 may be used within each group while option 2 is used across the groups. The grouping may itself be indicated as part of the event configuration, implicitly or explicitly. An implicit grouping could be conveyed via defining temporary variables. For example, all the conditions used in defining the temporary variable may constitute a group.

The network entity 105-a may configure the dynamic events (e.g., custom events) via control signaling 205. The control signaling 205 may be RRC signaling (e.g., an RRC message). For example, the RRC message may include an RRC IE indicating a list of dynamic events (e.g., a CustomEventConfigList RRC IE). The RRC IE may include a list of CustomEventConfigObjects, each representing an event definition. The objects may be added to or deleted from the list using RRC signaling (e.g., ToAddMod, or ToRelease mechanisms).

Each object in the list of objects may include one or more sub IEs, such as an eventID (e.g., an event identifier corresponding to a dynamically configured or preconfigured identifier), a ConditionList (e.g., a list of conditions as described herein, such as measurements falling within a range, state variables falling within a range, defined functions of multiple measurements/state variables falling into a range, a vector of measurements falling into a range, entering or leaving rules including hysteresis values, other conditions, or logical operators, among other examples), a ConditionCombiningLogic (e.g., operators combining one or more listed conditions), or the like. The eventIDs may be integers (e.g., while some predefined or static events may be defined with enumerated names such as eventA1, eventB2, or the like). In some examples, all events (e.g., static and dynamic or custom events) may be defined by eventIDs (e.g., defined in one or more standards documents, or configured via control signaling) such as integer eventIDs, for harmonization of (e.g., reference to both types of events using the same type of eventID).

In some examples, each condition of the ConditionList subIE may correspond to an associated index value. The ConditionCombiningLogic subIE may include a list of logical combinations of the conditions referred to by the index values of the ConditionList for an object in the CustomEventConfigList IE. The list (e.g., the list of conditions in the ConditionList) may include a mandatory output element, which may be the final combined condition of the list of conditions. The list of conditions may also include an intermediate condition that includes temporary variables used to more compactly specify the final condition. In some examples, indexing for such conditions may continue from the indexing in the ConditionList, or may be defined separately as a derivedConditionIndex used to label and refer to the temporary variables. Each element (e.g., each logical combination of conditions) may be represented as a list of symbols. Open and close parentheses may be utilized to denote allowed logical primitives (e.g., AND, OR<etc.), and indices representing the basic derived conditions. For example, when ConditionList IE has 6 elements indicated by indices 1 through 6, the ConditionList may read as follows:
tmp 1=(1∧2)∨(3∧4); tmp 2=5∨6; output=tmp 1 XOR tmp 2. In some examples, tmp 1, tmp 2 are numbered continuing from the ConditionList as 7 and 8 respectively, and output=7 XOR 8.

In some examples, the network entity 105-b may transmit control signaling 210. The control signaling 210 may include an RRC message (e.g., an RRC IE) including a report configuration (e.g., ReportConfig). The report configuration may indicate that the UE 115-a is to perform reporting for one or more events. In some examples, the control signaling 210 may include one or more index values corresponding to the values of the list of custom events (e.g., the events of the CustomEventConfigList). For example, for event-triggered report configuration (e.g., event-triggered dynamic events), the ReportConfig IE may use the eventID integer value (e.g., instead of an enumerated name) to refer to a dynamic object configured via the control signaling 205. For event reporting, the UE 115-a may be configured (e.g., by the control signaling 210) top report that an event has occurred (e.g., a measurement satisfies a threshold), or that an events conditions have been satisfied (e.g., that an entered state or a left state has been satisfied).

The UE may transmit a report 215. The UE 115-a may perform the event reporting via the report 215 (e.g., a control message, such as RRC signaling, a media access control (MAC) control element (CE), or an uplink control information (UCI) message). The report 215 may include an indication of an eventID (e.g., corresponding to an eventID indicated in the list of dynamic events). In some examples, the report 215 may also include an indication of one or more satisfied conditions, or a current (e.g., satisfied) state (e.g., such as an entered state or a left state). That is, the event may be reported for based on satisfaction of one or more conditions, and the UE 115-a may further report a current state (e.g., the conditions or measurements have entered a state, or the conditions or measurements have left a state).

Some events may correspond to conditional handover, or conditional reconfiguration. In such examples, the UE may report a list of close cells. The report may indicate the list of cells in terms of distance (e.g., from the UE 115-a), or measurements (e.g., measured RSRP), or the like.

Dynamic events may be added or removed from the CustomEventConfigList. When events are removed, all event-triggered report configurations (e.g., indicated via the control signaling 210) where the eventID of the removed event is included in the configured list of triggers, may be treated by the UE 115-a as if they have been reconfigured to remove the event from the list of triggers. That is, if an event is removed from the list of dynamic events, then the UE 115-a may assume that the corresponding eventID has been removed from the list of events identified in the report configuration (e.g., the ReportConfig). If such removal results in an empty list of triggers, the ReportConfig may be implicitly deemed to have been deleted, or the UE 115-a may treat the ReportConfig as having been deleted (e.g., the UE 115-a may stop reporting, but will restart reporting if an event with the same eventID is defined again). In some examples, the UE 115-a may assume that it has been implicitly switched to periodic reporting based on a default reporting rule or configuration (e.g., may utilize a fallback periodicity, instead of waiting for one or more reporting conditions to be satisfied). In some examples, the UE 115-a may treat removed eventIDs as undefined events, or as error cases (e.g., the UE 115-a may suspend all operations with that ReportConfig).

In some examples, one or more dynamic events may be defined with a subIE such as an eventActivationState IE (e.g., indicating an active or inactive state for the event). An inactive state for the event may be functionally equivalent to the event being removed from the list. Such indications of the event activation state may result in quick addition or deletion of events, without relying on RRC reconfiguration. Such indication of event activation states may be conveyed via layer 1 (L1) or layer 2 (L2) control signaling. A deleted (e.g. inactive) eventID occurring in the definition of a condition in another event may be treated as true, or triggered for evaluating that condition. In some examples, a deleted or inactive eventID may be treated as undefined and thus an error case by the UE 115-a.

The UE 115-a may parse the events (e.g., indicated in the control signaling 205). The UE 115-a may parse the event conditions (e.g., the list of conditions for each event including one or more subIEs), the combination string indicating the combined conditions, and any other subIEs. In some examples, the UE 115-a may experience one or more parser errors, such as a misaligned open and closed parentheses. Such errors may be treated as misconfiguration, and the UE 115-a may reject the configuration (e.g., the event, the report configuration for the event, or the full list of dynamic events). The UE 115-a may report such interpreted misconfiguration (e.g., rejections of configurations) to the network entity 105-a. In some examples, recursive definitions may be treated as parser or configuration errors, and may also be rejected. For example, if a definition dependency tree of a condition has loops (e.g., A depends on B, where B depends on C, which depends on A, or a loop in which A depends on A), the UE 115-a may reject the corresponding condition, set of conditions, or event, among other examples (e.g., and may report the rejection to the network entity 105-a). Some recursions may be resolvable (e.g., conditions such as A=B-A may appear recursive because A appears on both sides of the equation, however, the condition may be simplified as A=B/2, in which case the UE 115-a may be able to parse the conditions). However, depending on the UE capability, the UE 115-a may or may not be able to perform the additional parsing necessary to resolve the recursive nature of the condition, or determine whether the recursive condition is resolvable. In some cases, the UE 115-a may declare that it is not capable of performing the additional parsing, or of determining the resolvability of a condition, in which case the UE 115-a may reject the condition or conditions. In some examples, the UE 115-a may declare its capability via capability information 220, or in responsive to the control signaling 205, the control signaling 210, or a combination thereof.

The UE 115-a may perform monitoring for events (e.g., the events listed in the control signaling 205, or indicated via the control signaling 210, or both). The UE 115-a may monitor for entering or leaving conditions for some events, and may transmit reports 215 as indicated by the control signaling 210 (e.g., the report configuration). In some examples, the conditions may be complex, and executing different combinations of complex events may rely on a large amount of processing resources expended by the UE 115-a. In some cases, whether the UE 115-a is capable of executing combinations of complex events may be based on a current processing load at the UE 115-a (e.g., a processing load for any other actions being taken or pending at the UE 115-a).

In some examples, the UE 115-a may transmit capability information 220, which may indicate what events the UE 115-a is able to accept or execute. For example, the capability information 220 may bound what the UE 115-a can accept. In some examples, the UE 115-a may transmit capability information 220 (e.g., responsive to receiving the control signaling 205, the control signaling 210, or both) including an explicit acknowledgement that the UE 115-a sends to confirm whether it is able to handle any specific events or combinations of events configured by the network entity 105-a.

In some examples, dynamic events may be classified (e.g., via an indication in the control signaling 205, such as a subIE for a given event) as mandatory events, or optional events. A mandatory event may refer to an event that the UE 115-a is to accept and execute if the event falls within the UE capability (e.g., indicated via the capability information 220). An optional event may refer to an event that the UE is allowed to accept or reject, regardless of declared capability. The classification may depend on various attributes or conditions of the event, such as a quantity of conditions (e.g., if a quantity of conditions for a given event exceeds a threshold, then the event may be determined to be optional). The UE 115-a may transmit an indication of an acceptance, or a rejection of the optional events via an uplink control message (e.g., an RRC message, a MAC-CE message, or a UCI message). The message may refer to the eventIDs being acknowledged, a downlink configuration message (e.g., an identifier corresponding to the control signaling 205 that carries the list of events), a time-stamp of a downlink information message (e.g., a timestamp corresponding to the control signaling 205 or the control signaling 210), or any combination thereof. When an event configuration is indicated via a downlink message such as a MAC-CE or a DCI (e.g., the control signaling 205 may configure one or more events, and the control signaling 210 may be dynamic signaling that activates or deactivates candidate events), the UE 115-a may also reply via an acknowledgement message (e.g., a tri-state acknowledgement (ACK) message for the MAC-CE or the DCI). The tri-state ACK message may indicate that the configuration did not decode, that the configuration decoded but was rejected, or that the configuration was decoded and accepted. Such an ACK message may rely on a time offset value (e.g., K1 indicating an offset between the received physical downlink shared channel (PDSCH) and the transmitted ACK) to allow for event configuration parsing.

In some examples, when a configuration is rejected, the UE 115-a may provide variations of the configuration that the UE 115-a is able to accept. For example, the variants of the rejected configuration may include any combination of a subset of the events in the rejected configuration that the UE 115-a is able to accept, variations in (e.g., a subset of) the conditions or condition combinations of the rejected event that the UE 115-a is able to accept, a variation in periodicity with which the event entering or leaving conditions may be evaluated by the UE 115-a, or the like.

The UE 115-a may transmit capability information 220. The capability information may indicate whether the UE 115-a supports one or more attributes of custom events. For example, the capability information 220 may indicate a threshold quantity of events, a threshold quantity of conditions per event (e.g., or a total threshold quantity of conditions across all configured dynamic events), threshold quantity of condition combinations per event (e.g., or a total threshold quantity of combinations of conditions across all events), or any combination thereof. The capability information 220 may include an indication of a threshold length of (e.g., or a quantity of tokens in) each condition combination definition string, or a threshold total length across all definition strings per event, or across all events. The quantity of tokens may be counted separately for different types of tokens (e.g., one threshold quantity of logical operators, a threshold quantity of parentheses. a threshold quantity of condition indices, etc.), or all tokens may be counted together towards a total quantity supported by the UE 115-a. The capability information 220 may indicate a threshold depth of condition dependency. The capability information 220 may indicate a support or lack of support for particular types of measurements referred to in the event conditions (e.g., the UE 115-a may support all or a subset of PRS measurements, may support time difference of arrival (TDOA), or RSRP, or both), or may indicate one or more measurements that the UE 115-a does not support (e.g., orientation measurements, etc.).

The capability information 220 may indicate the UE capability to parse an event, or a UE capability to execute event monitoring or reporting, or any combination thereof. In some examples, the UE 115-a may report a single set of values indicating which events or conditions etc. the UE 115-a supports for both parsing and execution (e.g., monitoring). In some examples, the UE 115-a may report a first set of events or conditions (e.g., as described herein) that the UE 115-a supports for parsing, and a second set of events or conditions that the UE 115-a supports for execution (e.g., monitoring). In some examples, the capability information 220 may refer to only activated events (e.g., but may into include capability information to configured by deactivated or un-activated events). In some examples, the capability information 220 may refer to all configured events regardless of an activation status of the events. In some examples, the attributes reported may be different for activated events and deactivated events because the UE 115-a may report its capability to parse configured events and may also report a capability to parse and execute activated events. The capability information 220 may refer to mandatory events, optional events, or both. The parameters reported may be different for mandatory events than for optional events. In some examples, the capability reporting may refer to a single link (e.g., a Uu link, a sidelink, or the like), or to multiple links. In some examples, if multiple types of links are to be reported, the capability information 220 may include a first set of capabilities for a first link (e.g., a Uu link), and a second set of capabilities for a second link (e.g., one or more sidelink). Similarly, techniques described herein (e.g., including the capability signaling 205 and the capability signaling 210) may include configuration of events for or with respect to Uu links, sidelink, etc. In some examples, events may be configured for a sidelink by another UE (e.g., instead of the network entity 105-a).

In some examples, one or more measurement conditions (e.g., one or more parameters to be measured) may be defined. For example, a dynamic event (e.g., including one or more conditions or measurement objects) may be defined (e.g., configured via the control signaling 205). The event may include one or more measurement attributes (e.g., one or more parameters) for the UE 115-a to perform one or more measurements on one or more measured signals (e.g., on one or more reference signals). The measurement attributes may include a type of source for measured signals (e.g., a network entity 105, a UE 115 for sidelink scenarios, a relay-UE, a TRP, or the like). The measurement attributes may include an identifier of a source of the measured signals (e.g., a physical cell identifier (PCI), a cellGlobalID for a network entity, an international mobile subscriber identity (IMSI) for a UE 115, a PRS-ID for a TRP, etc.). Specific identifiers may be utilized to measure a particular physical node, or generic associations may be used based on a current state of the UE 115-a (e.g., a serving cell indicated in the measurement attributes may refer to any or all serving cells in a neighbor list, or any visible cells or camped cells in an idle or inactive mode, etc.). The measurement attributes may include an indication of a frequency occupancy of a signal (e.g., a frequency resource a frequency range (FR), a band, a carrier index, an ARFCN, etc.). Such indications of frequency resources may be specific (e.g., an indication of a particular ARFCN), or may be broad or generic (e.g., an indication that the UE 115-a is to use any or all supported or active ARFCNs within a specific FR, etc.).

The measurement attributes may include a physical channel name for a signal being measured (e.g., synchronization signal block (SSB), channel state information reference signal (CSI-RS), PRS, physical downlink control channel (PDCCH) demodulation reference signal (DMRS), PDCCH, etc.). The measurement attributes may include an indication of whether the UE 115-a is to measure a whole other the air channel (e.g., for RSRP measurements), or on a specific path or paths (e.g., specified via an index value or a range of delay or angle, among other examples). For example, the measurement attributes may include an indication of an n-th path for RSRP, or an indication that the UE 115-a is to perform measurements for all paths within a certain angular spread.

The measurement attributes may include a timestamp, a location stamp, or both, for a range of measurements (e.g., including whether the stamped measurement is a one-shot measurement or a periodic measurement). The measurement attributes may include an indication of a measurement quantity (e.g., a defined measurement quantity, such as RSRP, RSRQ, SINR<ToA, AoA, node location, node orientation, or the like). The measurement attributes may include an indication of a time-averaging duration, and one or more parameters for measurement (e.g., L1 or L3, L3 infinite impulse response (IIR) filter coefficients, or block-averaging windows, among other examples). The measurement attributes may include specifically named measurements corresponding to definitions in one or more standards documents (e.g., serving cell SS-RSRP, among other examples).

In some examples, a list of enumerated measurement attributes may be defined in one or more standards documents, or via control signaling, or both. The control signaling 205 configuring the list of events (e.g., one or more conditions corresponding to each event) may include one or more index values referring to the enumerated measurement attributes for a given event or condition. Some numeric attributes (e.g., cellIDs) may be configured numerically.

In some examples, state variable conditions (e.g., for a given event) may be defined (e.g., in one or more standards documents, via control signaling 205, or a combination thereof). When a UE 115-a measures or determines an internal state-variable (e.g., instead of measuring an over-the-air signal), such measurements may not be configured with reference to measurement attributes for measuring over-the-air signals. For example, state variable attributes may not be defined in terms of physical channels or frequency resources. Instead, the intended state-variable may be defined (e.g., as a condition of an event). In some scenarios, the control signaling 205 (e.g., the list of configured dynamic events) may include conditions or measurement parameters for each event, and some of the parameters may define state variable attributes that the UE 115-a is to measure or detect.

The state variable attributes may include one or more timers or counters (e.g., MAC timers or counters, RRC timers or counters, among other examples). In some examples, a list of counters or timers may be defined in one or more standards, and the control signaling 205 may include one or more indices indicating such timers as state variable attributes for the UE 115-a to measure.

The state variable attributes may be per UE, per cell-group (CG), per cell, or per any other group (e.g., per FR or frequency resources). In such examples, identifying the indicated state at the UE 115-a may include identifying a specific member in a grouping to which the state is associated (e.g., the UE 115-a may determine an MCG or SCG for per-CG states, or a CG-ID and primary secondary cell (PSCell) ID or secondary cell (SCell) ID for per-cell states). Such members may be identified via indices in the list of corresponding group members. In some examples, a listing of the state name may be included in the listing of the grouping IDs needed to reference it (e.g., the configuration may indicate FR:: WusConfigured for a per-frequency range scenario, or CG:: Cell:: SRSconfigured for a per-cell scenario).

In some examples, the state variable attributes may include a UE orientation, a temperature measured from a temperature sensor (e.g., to determine whether an ambient temperature satisfies a threshold or is within a range, or to determine a device internal temperature, or a temperature measured in a specific subsystem of the device, such as a Bluetooth subsystem or a power amplifier, among other examples). The UE 115-a and the network entity 105-a may agree (e.g., negotiate or configure) on a list of subsystem names that the UE 115-a supports (e.g., indicated via the capability information 220), and a subset of the list may be configured as state variable attributes for the UE 115-a to measure (e.g., detect). In some examples, other attributes of such subsystems may also be defined (e.g., and configured for UE measurement or detection), such as an on or off status of a subsystem, an activity level of a subsystem, a battery usage of a subsystem, or the like.

Some parameters configured at the UE 115-a for measurement (e.g., measurement attributes or state variable conditions) may be defined or associated with some canonical units. For example, an RSRP may be measured and reported in terms of dBm, SINR may be measured and reported in terms of dB. Some units for measurements may be defined in one or more standards documents. IN some examples, thresholds or other measurement quantities configured or used in defining an event condition may correspond to the same unites as the associated measurements. In some examples, units for derived quantities may be based on the underlying units for underlying quantities (e.g., the network entity 105-a may configure an event with a condition for measurement RSRP over time or distance, in which case canonical or default units for RSRP and canonical or default units for time or distance may be utilized and interpreted for the reported or triggering quantities).

In some examples, different units may be convenient in different scenarios, in which case the units may be configured or dynamically indicated. For example, the network entity 105-a may configure the UE 115-a to measure or report time in units of nanoseconds for round trip time (RTT) and TDOA, but may configure the UE 115-a to measure or report time in units of milliseconds for MAC timers (e.g., such as a DRX inactivity timer), or in seconds for RRC related timers. Temperature measurements and reports may be configured in units of Fahrenheit, or Celsius (e.g., depending on the situation, location, event), etc.

The network entity 105-a may configure parameters (e.g., for measurement or reporting) for dynamic events in accordance with a bitwidth, a range, a quantization granularity, or a combination thereof. The range and quantization granularity for measurements and conditions may be defined in one or more standards documents, may be preconfigured, or may be dynamically indicated by indexing to a tale of possible ranges and granularities. Similarly, bitwidths for configuring or reporting may be defined in one or more standards documents, preconfigured, or dynamically indicated via control signaling (e.g., via an index to a table). Nonlinear quantization tables mapping indexes to variable values may be utilized (e.g., mapping an integer index to an RSRP value in dBm). Such quantization tables may be defined in one or more standards, or may be indicated via configuration.

In some examples, additional information (e.g., specific side information) may be utilized (e.g., beyond unit and bitwidth information) for specific measurement quantities (e.g., for interpreting measurements and conditions). For example, a description of a position may be indicated via X, Y, Z (e.g., latitude, longitude, and height), and may be defined in ECEF, ENU, or local coordinates. In case of local coordinates, the relation between the local and the global coordinates or an identifier the local coordinate schemes may be used to indicate how to utilize, measure, report, or interpret the X, Y, Z coordinate information. In describing orientation using 3 coordinates, an indication of whether the coordinate represent Euler-angles, or Tai-Bryan angles, or an alternative description (e.g., such as quaternions) may be utilized (e.g., in addition to an indication of the units (e.g., degrees, minutes, milli-degrees, etc.) and bitwidth. Coordinate reference frames (e.g., based on which angels are measured) may also be defined (e.g., in the standards or via configuration).

In some examples, complex named measurements may be defined in the standards (e.g., as indexed entries in a table), and indicated via event configuration (e.g., via a list of configured events). Simple index values or simple information in the configuration information may then be utilized to reference highly complex events or conditions or measurement parameters (e.g., to reduce the complexity of some measurement conditions). For example, a condition corresponding to measurement of device acceleration may be described using a second derivative of a position with respect to time. A condition such as an indication that the device is rotating may be described using a first derivative of the orientation with respect to time. However, because the rotation axis is left unspecified, rotation could be measured along multiple axes and a metric could be defined for total rotation. Such description might be complex, resulting in increased signaling overhead to define the measurement parameters and conditions for a given event. By defining some measurement conditions in the standards, the dynamic events may still be configured without reliance of all events being defined in the standards, while decreasing signaling overhead and simplifying configuration of dynamic events.

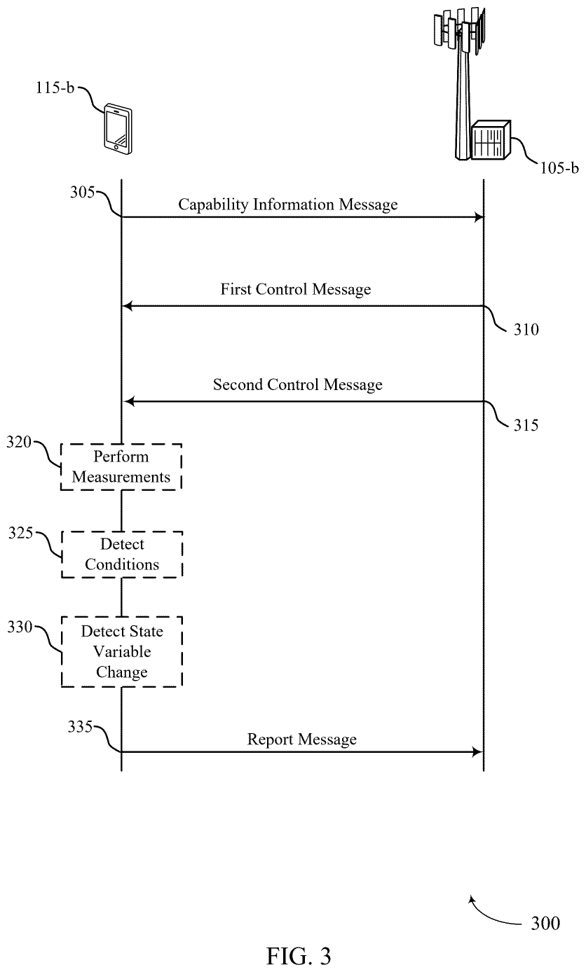

FIG. 3 shows an example of a process flow 300 that supports flexible event configuration in accordance with one or more aspects of the present disclosure. The process flow 300 may implement, or be implemented by, aspects of the wireless communications system 100 and the wireless communications system 200. For example, the process flow 300 may include a UE 115-b and a network entity 105-b, which may be examples of corresponding devices described with reference to FIGS. 1-2. The steps performed by the wireless devices as described with reference to the process flow 300 may be performed in any order.

At 305, the UE 115-b may transmit (e.g., to the network entity 105-b) a capability information message. The capability information message may indicate whether the UE 115-b is capable of reading (e.g., parsing) an indication of at least one dynamically configured event (e.g., a custom event), detecting whether one or more conditions corresponding to the at least one dynamically event are satisfied (e.g., executing the measurement objects or detecting the conditions corresponding to a custom event), or both. In some examples, the capability information may include an indication of a threshold quantity of events of the list of dynamically configured events, a set of combinations of multiple conditions the UE is capable of monitoring, a threshold quantity of information in the list of dynamically configured events, a threshold quantity of conditions corresponding to each event of the list of dynamically configured events, a dependency depth for each event of the list of dynamically configured events, or any combination thereof (e.g., as described in greater detail with reference to FIG. 2).

At 310, the UE 115-b may receive (e.g., from the network entity 105-b, or from another device such as a UE in a sidelink deployment, a relay UE, a TRP, or the like) a first control message (e.g., an RRC message) including a list of dynamically configured events (e.g., a custom event list). Each dynamically configured event of the list may correspond to a set of parameters (e.g., conditions, entering or exit conditions, measurement attributes, state variable attributes, units or quantization of measurements or reports, etc.). Each event of the list of events may correspond to an index value (e.g., an integer number). In some examples, the parameters for each event may include a range of values defined by a set of measurements, a set of operators, a table, an index corresponding to a preconfigured or configured table, or the like. In some examples, the parameters may include a subset of values of a vector, or a subset of volume of three-dimensional space, or a result of a function, among other examples. In such examples, detecting that one or more conditions have been satisfied may include a determination that one or more measurements fall within the range of values, the subset of the vector, etc.

At 315, the UE 115-b may receive a second control message (e.g., a ReportConfig message, such as for event-triggered events, a DCI or MAC-CE triggering or activating a configured event listed at 310). The second control message may include an index value referring to an integer number corresponding to an event of the list of events.

Each dynamically configured event may be based on the capability information message. For example, the network entity 105-b may receive the capability information message, and may configure events, or define events with one or more conditions, in accordance with the received capability information message.

At 335, the UE 115-b may transmit a report message indicating the occurrence of at least a first event of the list of events, based at least in part on detecting that one or more conditions corresponding to the first event are satisfied (e.g., at 320, 325, 330, or any combination thereof).

In some examples (e.g., at 320), the UE 115-b may detect that the one or more conditions corresponding to the first event are satisfied by performing one or more measurements. The measurements may be performed in accordance with the one or more parameters corresponding to the condition (e.g., measurement attributes defined by the subIEs for the dynamic event). The one or more parameters (e.g., conditions) may include an identifier of the one or more received signals, a frequency occupancy of the one or more received signals, a channel identifier corresponding to the one or more parameters, a time stamp corresponding to the one or more received signals, a measurement quantity corresponding to the one or more measurements, a time duration corresponding to the one or more measurements, a measurement identifier corresponding to the one or more measurements, or any combination thereof. Based on the information (e.g., the one or more parameters) corresponding to the conditions of the event, the UE 115-b may receive one or more signals (e.g., reference signals indicated by a signal identifier, or a channel identifier, or from a particular device based on a device identifier or device type identifier, among other examples), and may perform one or more measurements (e.g., a measurement quantity, such as RSRP or SINR, or a more specifically indicated measurement indicated as part of the event configuration at 310). Based on the measurements, the UE 115-b may determine that the one or more measurements satisfy the one or more conditions (e.g., a measured quantity satisfies a threshold or falls within a range, or a set of measured quantities defined as a vector or three dimensional space satisfies a threshold or falls within a subset of the vector or a volume of three dimensional space, among other examples).

In some examples, at 325, the UE 115-b may determine that one or more conditions are satisfied, and then may perform one or more measurements based on satisfaction of the conditions (e.g., a second set of conditions, such as measurement values, may depend on a first set of conditions, such as detected states). For instance, an event may be defined such that one or more measurements are to be made and reported if one or more additional conditions are satisfied. The UE 115-b may perform an initial set of measurements or detect one or more states (e.g., may determine that a location, speed, direction, device type, or cell identifier satisfies one or more conditions), and if the conditions or states satisfy a first set of conditions, then the UE 115-b may perform one or more measurements on one or more received signals based on the first set of conditions being satisfied. If the second set of conditions are satisfied (e.g., if the measurements satisfy a threshold or fall within a range), then the UE 115-b may transmit a report message (e.g., triggered or periodically), or perform an action (e.g., initiate a handover or other change of behavior). In such examples, the one or more parameters may include an index value corresponding to one or more parameters, where each index value corresponds to a respective candidate set of parameters. Thus, the measurement attributes for an event may include event name for device type, cell ID, height, etc. If the height, location, etc. satisfies the conditions, then the UE performs additional measurements (e.g., as described in greater detail with reference to FIG. 2).

In some examples (e.g., at 330), the UE 115-b may detect a state variable change (e.g., in accordance with one or more parameters or conditions configured at 310). For example, the UE 115-b may detect that a state variable has changed. The parameters or conditions configured at 310 for the event may include state variables such as expiration of a timer, a counter value satisfying a threshold, a connection state, a location of the UE, or the like (e.g., as described in greater detail with reference to FIG. 2).

At 335, the UE 115-b may transmit a report message to the network entity 105-b. The report message may indicate that an event has occurred, may include measurement values, an indication of a current or previous state of one or more variable states, or the like. In some examples, the UE 115-b may report one or more error cases, or one or more configured events that the UE 115-b is not capable of parsing or executing. In some cases, the UE 115-b may transmit an ACK message indicating one or more events of the list of events that the UE 115-b supports or will be able to parse or execute.

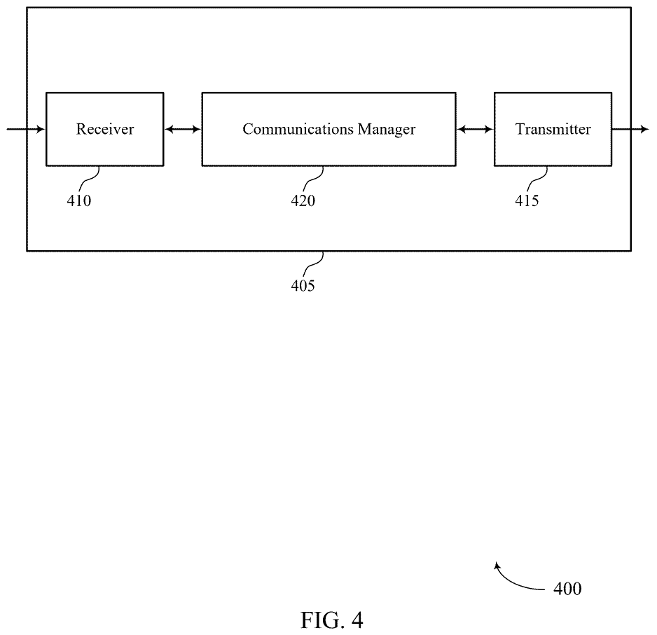

FIG. 4 shows a block diagram 400 of a device 405 that supports flexible event configuration in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to flexible event configuration). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to flexible event configuration). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of flexible event configuration as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for transmitting a capability information message indicating that the UE is capable of reading an indication of at least one dynamically configured event, detecting whether conditions corresponding to the at least one dynamically configured event are satisfied, or both. The communications manager 420 is capable of, configured to, or operable to support a means for receiving a radio resource control message including a list of dynamically configured events, each dynamically configured event corresponding to a set of multiple parameters, where each dynamically configured event is based on the capability information message. The communications manager 420 is capable of, configured to, or operable to support a means for receiving a control message indicating one or more parameters for reporting an occurrence of at least a first event of the list of dynamically configured events. The communications manager 420 is capable of, configured to, or operable to support a means for transmitting a report message indicating the occurrence of the first event based on detecting that one or more conditions corresponding to the first event are satisfied.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for flexible event configuration and reporting resulting in reduced processing, more efficient utilization of available system resources, more accurate flow of information, improved ML or AI model development and accuracy, and improved user experience.

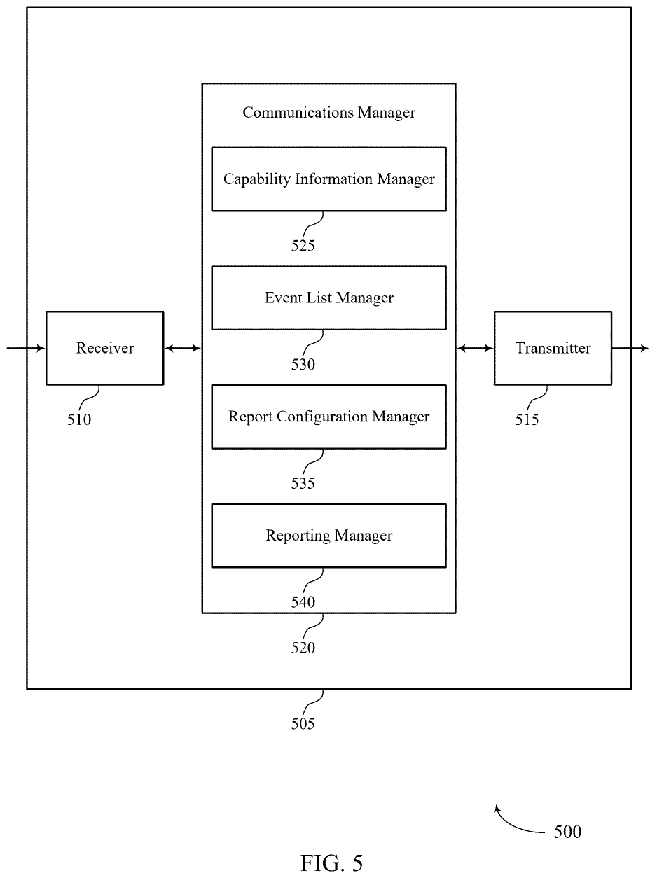

FIG. 5 shows a block diagram 500 of a device 505 that supports flexible event configuration in accordance with one or more aspects of the present disclosure. The device 505 may be an example of aspects of a device 405 or a UE 115 as described herein. The device 505 may include a receiver 510, a transmitter 515, and a communications manager 520. The device 505, or one of more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to flexible event configuration). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to flexible event configuration). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of flexible event configuration as described herein. For example, the communications manager 520 may include a capability information manager 525, an event list manager 530, a report configuration manager 535, a reporting manager 540, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The capability information manager 525 is capable of, configured to, or operable to support a means for transmitting a capability information message indicating that the UE is capable of reading an indication of at least one dynamically configured event, detecting whether conditions corresponding to the at least one dynamically configured event are satisfied, or both. The event list manager 530 is capable of, configured to, or operable to support a means for receiving a radio resource control message including a list of dynamically configured events, each dynamically configured event corresponding to a set of multiple parameters, where each dynamically configured event is based on the capability information message. The report configuration manager 535 is capable of, configured to, or operable to support a means for receiving a control message indicating one or more parameters for reporting an occurrence of at least a first event of the list of dynamically configured events. The reporting manager 540 is capable of, configured to, or operable to support a means for transmitting a report message indicating the occurrence of the first event based on detecting that one or more conditions corresponding to the first event are satisfied.

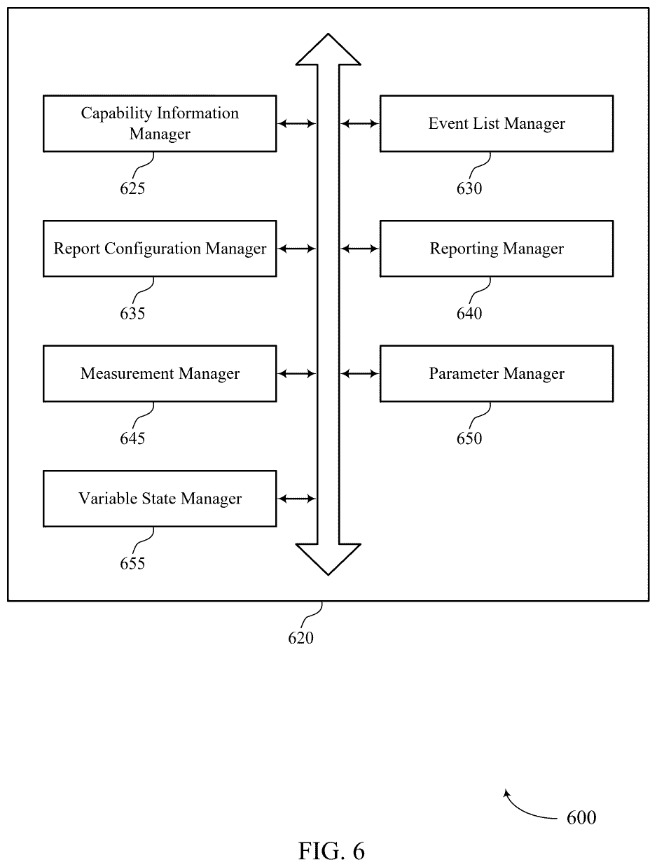

FIG. 6 shows a block diagram 600 of a communications manager 620 that supports flexible event configuration in accordance with one or more aspects of the present disclosure. The communications manager 620 may be an example of aspects of a communications manager 420, a communications manager 520, or both, as described herein. The communications manager 620, or various components thereof, may be an example of means for performing various aspects of flexible event configuration as described herein. For example, the communications manager 620 may include a capability information manager 625, an event list manager 630, a report configuration manager 635, a reporting manager 640, a measurement manager 645, a parameter manager 650, a variable state manager 655, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The capability information manager 625 is capable of, configured to, or operable to support a means for transmitting a capability information message indicating that the UE is capable of reading an indication of at least one dynamically configured event, detecting whether conditions corresponding to the at least one dynamically configured event are satisfied, or both. The event list manager 630 is capable of, configured to, or operable to support a means for receiving a radio resource control message including a list of dynamically configured events, each dynamically configured event corresponding to a set of multiple parameters, where each dynamically configured event is based on the capability information message. The report configuration manager 635 is capable of, configured to, or operable to support a means for receiving a control message indicating one or more parameters for reporting an occurrence of at least a first event of the list of dynamically configured events. The reporting manager 640 is capable of, configured to, or operable to support a means for transmitting a report message indicating the occurrence of the first event based on detecting that one or more conditions corresponding to the first event are satisfied.

In some examples, the capability information message includes an indication of a threshold quantity of events of the list of dynamically configured events, a set of combinations of a set of multiple conditions the UE is capable of monitoring, a threshold quantity of information in the list of dynamically configured events, a threshold quantity of conditions corresponding to each event of the list of dynamically configured events, a dependency depth for each event of the list of dynamically configured events, or any combination thereof.

In some examples, to support detecting that one or more conditions corresponding to the first event are satisfied, the measurement manager 645 is capable of, configured to, or operable to support a means for performing one or more measurements on one or more received signals. In some examples, to support detecting that one or more conditions corresponding to the first event are satisfied, the measurement manager 645 is capable of, configured to, or operable to support a means for determining that the one or more measurements satisfy the one or more conditions.

In some examples, the one or more parameters corresponding to the first event includes an identifier of the one or more received signals, a frequency occupancy of the one or more received signals, a channel identifier corresponding to the one or more parameters, a time stamp corresponding to the one or more received signals, a measurement quantity corresponding to the one or more measurements, a time duration corresponding to the one or more measurements, a measurement identifier corresponding to the one or more measurements, or any combination thereof.

In some examples, to support detecting that one or more conditions corresponding to the first event are satisfied, the parameter manager 650 is capable of, configured to, or operable to support a means for determining that a location, speed, direction, device type, or cell identifier satisfy the one or more conditions. In some examples, to support detecting that one or more conditions corresponding to the first event are satisfied, the parameter manager 650 is capable of, configured to, or operable to support a means for performing one or more measurements on one or more received signals based on the one or more conditions being satisfied.

In some examples, the one or more parameters corresponding to the first event includes an index value corresponding to the one or more parameters, each index value of a set of index values including the first event corresponds to a respective candidate set of parameters.

In some examples, to support detecting that one or more conditions corresponding to the first event are satisfied, the variable state manager 655 is capable of, configured to, or operable to support a means for detecting that a state variable has changed, the state variable including expiration of a timer, a counter value satisfying a threshold, a connection state, a location of the UE, or any combination thereof.

In some examples, the set of multiple parameters corresponding to the first event includes a range of values defined by a set of measurements, a set of operators, a table, or a combination thereof. In some examples, detecting that the one or more conditions are satisfied includes determining that a measured value or detected state falls within the range of values.

In some examples, the set of multiple parameters corresponding to the first event includes a subset of values of a vector. In some examples, detecting that the one or more conditions are satisfied includes determining that a set of measured values or detected states are defined within the subset of values.

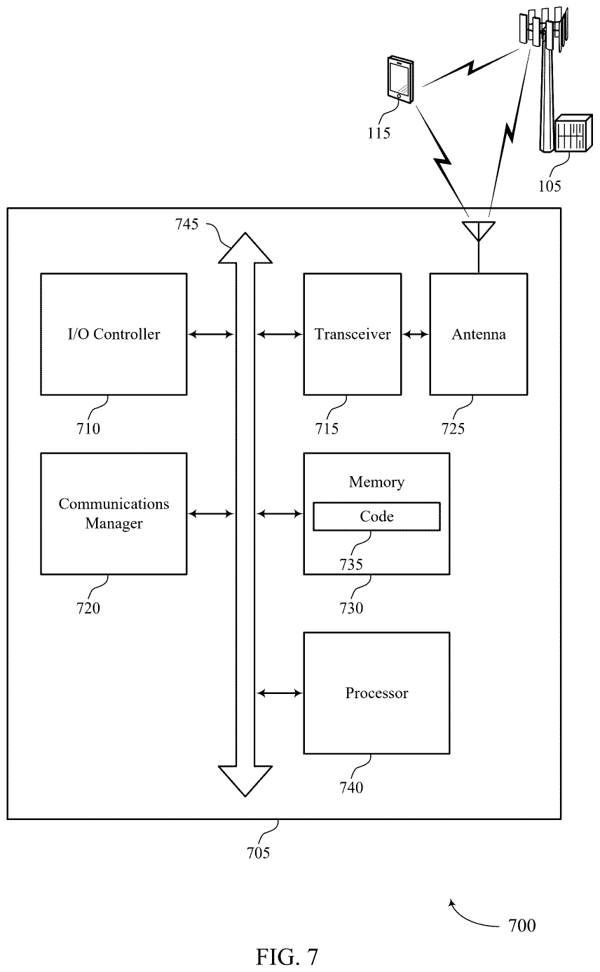

FIG. 7 shows a diagram of a system 700 including a device 705 that supports flexible event configuration in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting flexible event configuration). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for transmitting a capability information message indicating that the UE is capable of reading an indication of at least one dynamically configured event, detecting whether conditions corresponding to the at least one dynamically configured event are satisfied, or both. The communications manager 720 is capable of, configured to, or operable to support a means for receiving a radio resource control message including a list of dynamically configured events, each dynamically configured event corresponding to a set of multiple parameters, where each dynamically configured event is based on the capability information message. The communications manager 720 is capable of, configured to, or operable to support a means for receiving a control message indicating one or more parameters for reporting an occurrence of at least a first event of the list of dynamically configured events. The communications manager 720 is capable of, configured to, or operable to support a means for transmitting a report message indicating the occurrence of the first event based on detecting that one or more conditions corresponding to the first event are satisfied.

By including or configuring the communications manager 720 in accordance with examples as described herein, the device 705 may support techniques for flexible event configuration and reporting resulting in reduced processing, more efficient utilization of available system resources, improved communication reliability, decreased signaling overhead, more accurate flow of information, improved coordination between devices improved ML or AI model development and accuracy, and improved user experience.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of flexible event configuration as described herein, or the at least one processor 740 and the at least one memory 730 may be otherwise configured to, individually or collectively, perform or support such operations.

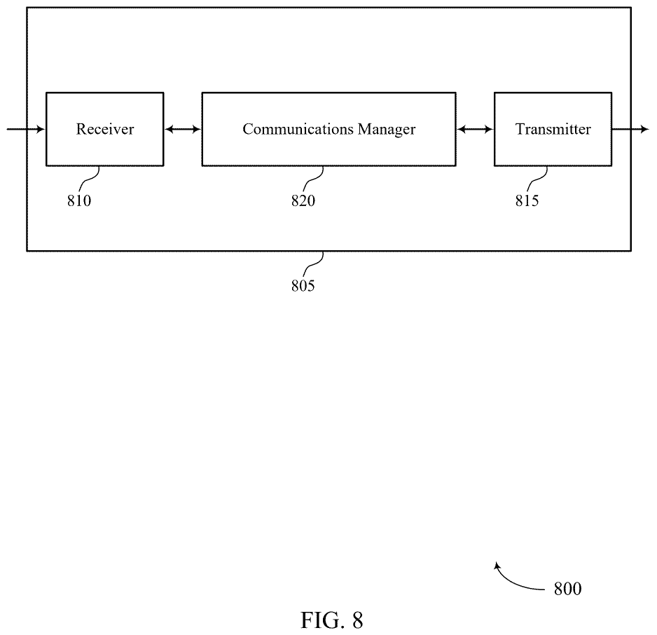

FIG. 8 shows a block diagram 800 of a device 805 that supports flexible event configuration in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of flexible event configuration as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for receiving a capability information message indicating that a UE is capable of reading an indication of at least one dynamically configured event, detecting whether conditions corresponding to the at least one dynamically configured event are satisfied, or both. The communications manager 820 is capable of, configured to, or operable to support a means for transmitting a radio resource control message including a list of dynamically configured events, each dynamically configured event corresponding to a set of multiple parameters, where each dynamically configured event is based on the capability information message. The communications manager 820 is capable of, configured to, or operable to support a means for transmitting a control message indicating one or more parameters for reporting an occurrence of at least a first event of the list of dynamically configured events. The communications manager 820 is capable of, configured to, or operable to support a means for receiving a report message indicating the occurrence of the first event associated with one or more conditions corresponding to the first event being satisfied.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for flexible event configuration and reporting resulting in reduced processing, more efficient utilization of available system resources, more accurate flow of information, improved ML or AI model development and accuracy, and improved user experience.

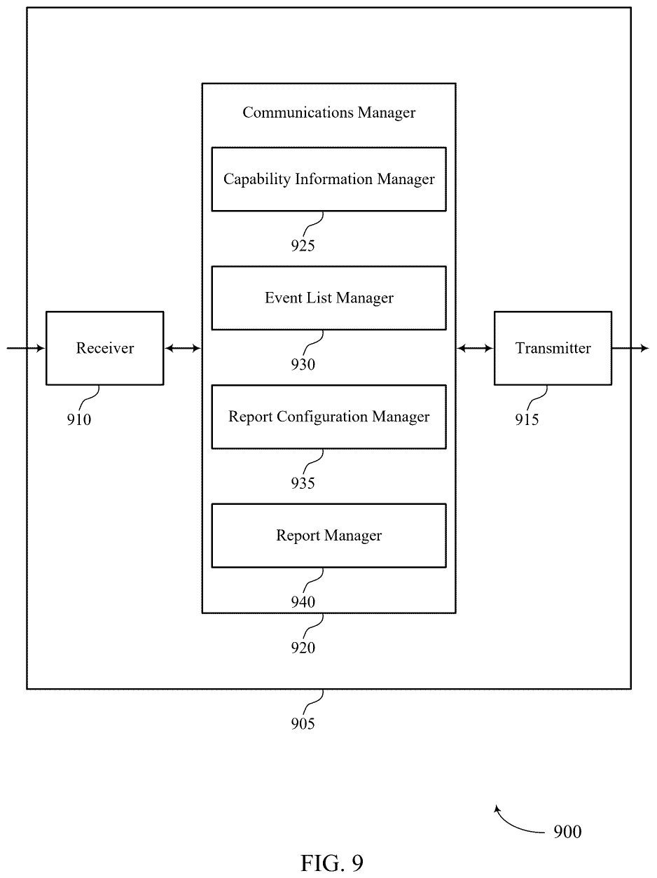

FIG. 9 shows a block diagram 900 of a device 905 that supports flexible event configuration in accordance with one or more aspects of the present disclosure. The device 905 may be an example of aspects of a device 805 or a network entity 105 as described herein. The device 905 may include a receiver 910, a transmitter 915, and a communications manager 920. The device 905, or one of more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of flexible event configuration as described herein. For example, the communications manager 920 may include a capability information manager 925, an event list manager 930, a report configuration manager 935, a report manager 940, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The capability information manager 925 is capable of, configured to, or operable to support a means for receiving a capability information message indicating that a UE is capable of reading an indication of at least one dynamically configured event, detecting whether conditions corresponding to the at least one dynamically configured event are satisfied, or both. The event list manager 930 is capable of, configured to, or operable to support a means for transmitting a radio resource control message including a list of dynamically configured events, each dynamically configured event corresponding to a set of multiple parameters, where each dynamically configured event is based on the capability information message. The report configuration manager 935 is capable of, configured to, or operable to support a means for transmitting a control message indicating one or more parameters for reporting an occurrence of at least a first event of the list of dynamically configured events. The report manager 940 is capable of, configured to, or operable to support a means for receiving a report message indicating the occurrence of the first event associated with one or more conditions corresponding to the first event being satisfied.

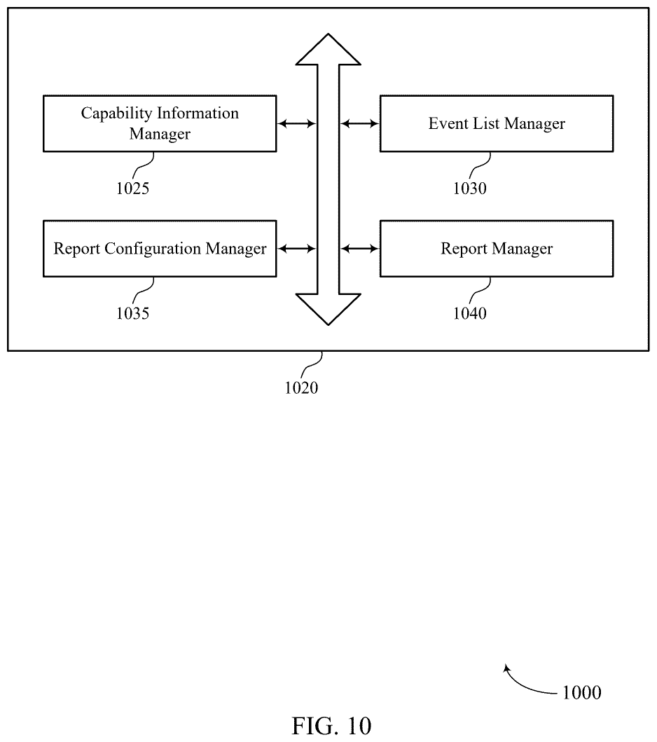

FIG. 10 shows a block diagram 1000 of a communications manager 1020 that supports flexible event configuration in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of flexible event configuration as described herein. For example, the communications manager 1020 may include a capability information manager 1025, an event list manager 1030, a report configuration manager 1035, a report manager 1040, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The capability information manager 1025 is capable of, configured to, or operable to support a means for receiving a capability information message indicating that a UE is capable of reading an indication of at least one dynamically configured event, detecting whether conditions corresponding to the at least one dynamically configured event are satisfied, or both. The event list manager 1030 is capable of, configured to, or operable to support a means for transmitting a radio resource control message including a list of dynamically configured events, each dynamically configured event corresponding to a set of multiple parameters, where each dynamically configured event is based on the capability information message. The report configuration manager 1035 is capable of, configured to, or operable to support a means for transmitting a control message indicating one or more parameters for reporting an occurrence of at least a first event of the list of dynamically configured events. The report manager 1040 is capable of, configured to, or operable to support a means for receiving a report message indicating the occurrence of the first event associated with one or more conditions corresponding to the first event being satisfied.

In some examples, the capability information message includes an indication of a threshold quantity of events of the list of dynamically configured events, a set of combinations of a set of multiple conditions the UE is capable of monitoring, a threshold quantity of information in the list of dynamically configured events, a threshold quantity of conditions corresponding to each event of the list of dynamically configured events, a dependency depth for each event of the list of dynamically configured events, or any combination thereof.

In some examples, the one or more parameters corresponding to the first event includes an identifier of the one or more received signals, a frequency occupancy of the one or more received signals, a channel identifier corresponding to the one or more parameters, a time stamp corresponding to the one or more received signals, a measurement quantity corresponding to the one or more measurements, a time duration corresponding to the one or more measurements, a measurement identifier corresponding to the one or more measurements, or any combination thereof.

In some examples, the one or more parameters corresponding to the first event includes an index value corresponding to the one or more parameters, each index value of a set of index values including the first event corresponds to a respective candidate set of parameters.

In some examples, the set of multiple parameters corresponding to the first event includes a range of values defined by a set of measurements, a set of operators, a table, or a combination thereof. In some examples, detecting that the one or more conditions are satisfied includes determining that a measured value or detected state falls within the range of values.

In some examples, the set of multiple parameters corresponding to the first event includes a subset of values of a vector. In some examples, detecting that the one or more conditions are satisfied includes determining that a set of measured values or detected states are defined within the subset of values.

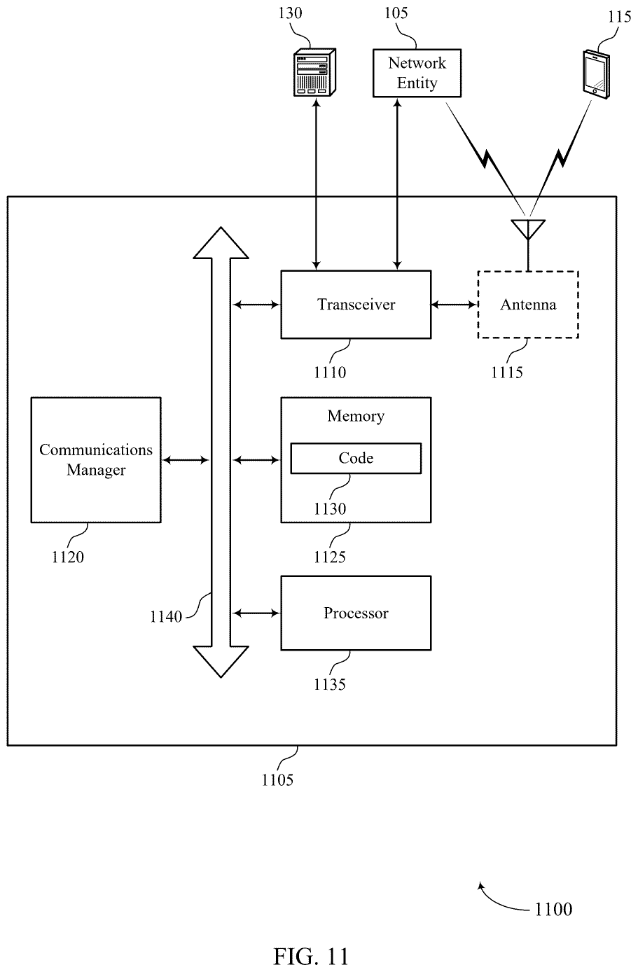

FIG. 11 shows a diagram of a system 1100 including a device 1105 that supports flexible event configuration in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting flexible event configuration). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for receiving a capability information message indicating that a UE is capable of reading an indication of at least one dynamically configured event, detecting whether conditions corresponding to the at least one dynamically configured event are satisfied, or both. The communications manager 1120 is capable of, configured to, or operable to support a means for transmitting a radio resource control message including a list of dynamically configured events, each dynamically configured event corresponding to a set of multiple parameters, where each dynamically configured event is based on the capability information message. The communications manager 1120 is capable of, configured to, or operable to support a means for transmitting a control message indicating one or more parameters for reporting an occurrence of at least a first event of the list of dynamically configured events. The communications manager 1120 is capable of, configured to, or operable to support a means for receiving a report message indicating the occurrence of the first event associated with one or more conditions corresponding to the first event being satisfied.

By including or configuring the communications manager 1120 in accordance with examples as described herein, the device 1105 may support techniques for flexible event configuration and reporting resulting in reduced processing, more efficient utilization of available system resources, improved communication reliability, decreased signaling overhead, more accurate flow of information, improved coordination between devices improved ML or AI model development and accuracy, and improved user experience.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of flexible event configuration as described herein, or the at least one processor 1135 and the at least one memory 1125 may be otherwise configured to, individually or collectively, perform or support such operations.

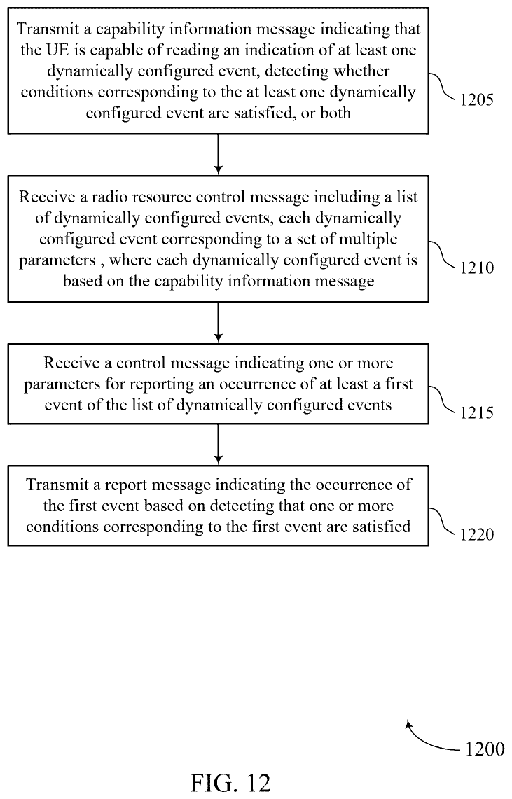

FIG. 12 shows a flowchart illustrating a method 1200 that supports flexible event configuration in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include transmitting a capability information message indicating that the UE is capable of reading an indication of at least one dynamically configured event, detecting whether conditions corresponding to the at least one dynamically configured event are satisfied, or both. The operations of 1205 may be performed in accordance with examples as disclosed herein. In some examples, aspects of the operations of 1205 may be performed by a capability information manager 625 as described with reference to FIG. 6.

At 1210, the method may include receiving a radio resource control message including a list of dynamically configured events, each dynamically configured event corresponding to a set of multiple parameters, where each dynamically configured event is based on the capability information message. The operations of 1210 may be performed in accordance with examples as disclosed herein. In some examples, aspects of the operations of 1210 may be performed by an event list manager 630 as described with reference to FIG. 6.

At 1215, the method may include receiving a control message indicating one or more parameters for reporting an occurrence of at least a first event of the list of dynamically configured events. The operations of 1215 may be performed in accordance with examples as disclosed herein. In some examples, aspects of the operations of 1215 may be performed by a report configuration manager 635 as described with reference to FIG. 6.

At 1220, the method may include transmitting a report message indicating the occurrence of the first event based on detecting that one or more conditions corresponding to the first event are satisfied. The operations of 1220 may be performed in accordance with examples as disclosed herein. In some examples, aspects of the operations of 1220 may be performed by a reporting manager 640 as described with reference to FIG. 6.

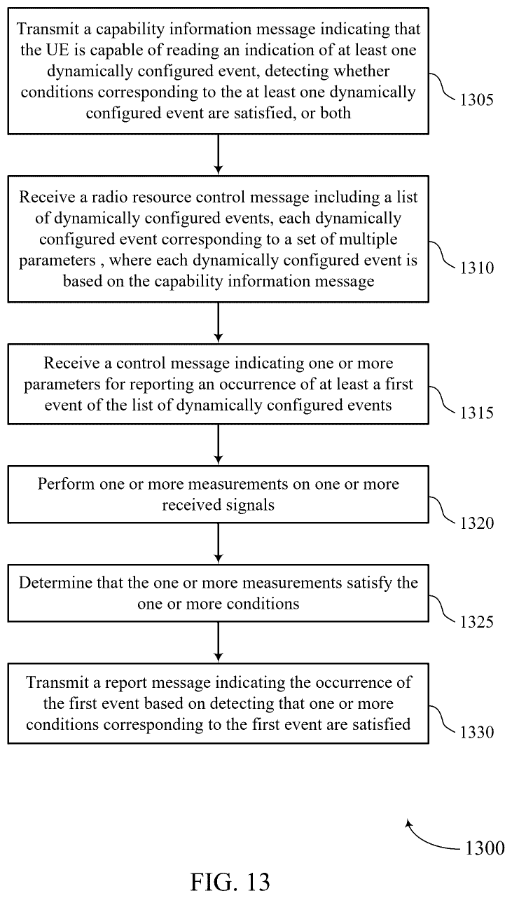

FIG. 13 shows a flowchart illustrating a method 1300 that supports flexible event configuration in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include transmitting a capability information message indicating that the UE is capable of reading an indication of at least one dynamically configured event, detecting whether conditions corresponding to the at least one dynamically configured event are satisfied, or both. The operations of 1305 may be performed in accordance with examples as disclosed herein. In some examples, aspects of the operations of 1305 may be performed by a capability information manager 625 as described with reference to FIG. 6.

At 1310, the method may include receiving a radio resource control message including a list of dynamically configured events, each dynamically configured event corresponding to a set of multiple parameters, where each dynamically configured event is based on the capability information message. The operations of 1310 may be performed in accordance with examples as disclosed herein. In some examples, aspects of the operations of 1310 may be performed by an event list manager 630 as described with reference to FIG. 6.

At 1315, the method may include receiving a control message indicating one or more parameters for reporting an occurrence of at least a first event of the list of dynamically configured events. The operations of 1315 may be performed in accordance with examples as disclosed herein. In some examples, aspects of the operations of 1315 may be performed by a report configuration manager 635 as described with reference to FIG. 6.

At 1320, the method may include performing one or more measurements on one or more received signals. The operations of 1320 may be performed in accordance with examples as disclosed herein. In some examples, aspects of the operations of 1320 may be performed by a measurement manager 645 as described with reference to FIG. 6.

At 1325, the method may include determining that the one or more measurements satisfy the one or more conditions. The operations of 1325 may be performed in accordance with examples as disclosed herein. In some examples, aspects of the operations of 1325 may be performed by a measurement manager 645 as described with reference to FIG. 6.

At 1330, the method may include transmitting a report message indicating the occurrence of the first event based on detecting that one or more conditions corresponding to the first event are satisfied. The operations of 1330 may be performed in accordance with examples as disclosed herein. In some examples, aspects of the operations of 1330 may be performed by a reporting manager 640 as described with reference to FIG. 6.

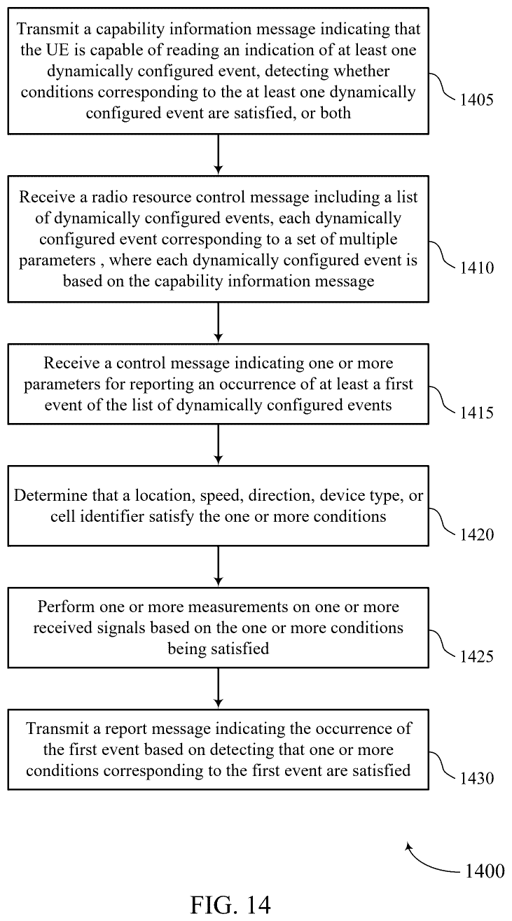

FIG. 14 shows a flowchart illustrating a method 1400 that supports flexible event configuration in accordance with one or more aspects of the present disclosure. The operations of the method 1400 may be implemented by a UE or its components as described herein. For example, the operations of the method 1400 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1405, the method may include transmitting a capability information message indicating that the UE is capable of reading an indication of at least one dynamically configured event, detecting whether conditions corresponding to the at least one dynamically configured event are satisfied, or both. The operations of 1405 may be performed in accordance with examples as disclosed herein. In some examples, aspects of the operations of 1405 may be performed by a capability information manager 625 as described with reference to FIG. 6.

At 1410, the method may include receiving a radio resource control message including a list of dynamically configured events, each dynamically configured event corresponding to a set of multiple parameters, where each dynamically configured event is based on the capability information message. The operations of 1410 may be performed in accordance with examples as disclosed herein. In some examples, aspects of the operations of 1410 may be performed by an event list manager 630 as described with reference to FIG. 6.

At 1415, the method may include receiving a control message indicating one or more parameters for reporting an occurrence of at least a first event of the list of dynamically configured events. The operations of 1415 may be performed in accordance with examples as disclosed herein. In some examples, aspects of the operations of 1415 may be performed by a report configuration manager 635 as described with reference to FIG. 6.

At 1420, the method may include determining that a location, speed, direction, device type, or cell identifier satisfy the one or more conditions. The operations of 1420 may be performed in accordance with examples as disclosed herein. In some examples, aspects of the operations of 1420 may be performed by a parameter manager 650 as described with reference to FIG. 6.

At 1425, the method may include performing one or more measurements on one or more received signals based on the one or more conditions being satisfied. The operations of 1425 may be performed in accordance with examples as disclosed herein. In some examples, aspects of the operations of 1425 may be performed by a parameter manager 650 as described with reference to FIG. 6.

At 1430, the method may include transmitting a report message indicating the occurrence of the first event based on detecting that one or more conditions corresponding to the first event are satisfied. The operations of 1430 may be performed in accordance with examples as disclosed herein. In some examples, aspects of the operations of 1430 may be performed by a reporting manager 640 as described with reference to FIG. 6.

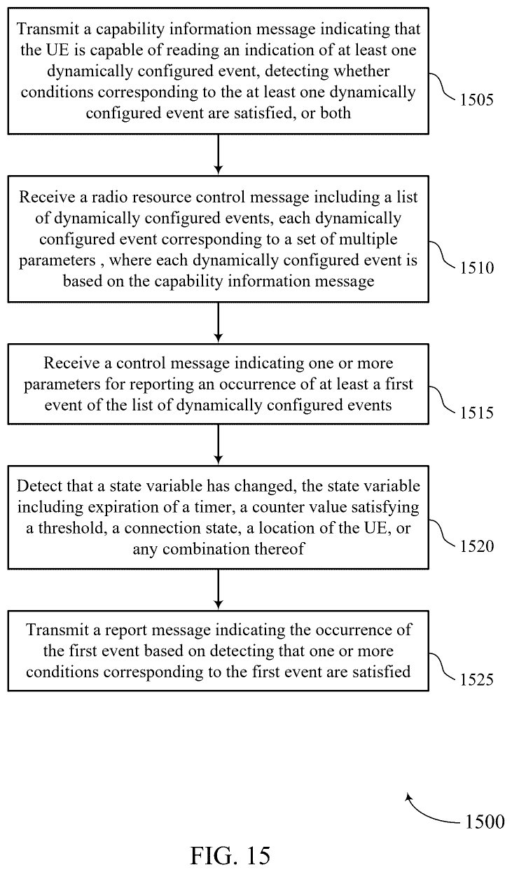

FIG. 15 shows a flowchart illustrating a method 1500 that supports flexible event configuration in accordance with one or more aspects of the present disclosure. The operations of the method 1500 may be implemented by a UE or its components as described herein. For example, the operations of the method 1500 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1505, the method may include transmitting a capability information message indicating that the UE is capable of reading an indication of at least one dynamically configured event, detecting whether conditions corresponding to the at least one dynamically configured event are satisfied, or both. The operations of 1505 may be performed in accordance with examples as disclosed herein. In some examples, aspects of the operations of 1505 may be performed by a capability information manager 625 as described with reference to FIG. 6.

At 1510, the method may include receiving a radio resource control message including a list of dynamically configured events, each dynamically configured event corresponding to a set of multiple parameters, where each dynamically configured event is based on the capability information message. The operations of 1510 may be performed in accordance with examples as disclosed herein. In some examples, aspects of the operations of 1510 may be performed by an event list manager 630 as described with reference to FIG. 6.

At 1515, the method may include receiving a control message indicating one or more parameters for reporting an occurrence of at least a first event of the list of dynamically configured events. The operations of 1515 may be performed in accordance with examples as disclosed herein. In some examples, aspects of the operations of 1515 may be performed by a report configuration manager 635 as described with reference to FIG. 6.

At 1520, the method may include detecting that a state variable has changed, the state variable including expiration of a timer, a counter value satisfying a threshold, a connection state, a location of the UE, or any combination thereof. The operations of 1520 may be performed in accordance with examples as disclosed herein. In some examples, aspects of the operations of 1520 may be performed by a variable state manager 655 as described with reference to FIG. 6.

At 1525, the method may include transmitting a report message indicating the occurrence of the first event based on detecting that one or more conditions corresponding to the first event are satisfied. The operations of 1525 may be performed in accordance with examples as disclosed herein. In some examples, aspects of the operations of 1525 may be performed by a reporting manager 640 as described with reference to FIG. 6.

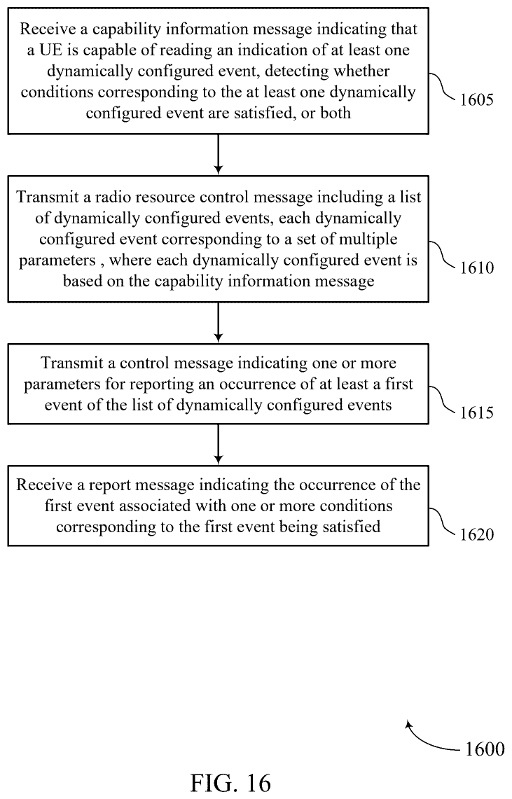

FIG. 16 shows a flowchart illustrating a method 1600 that supports flexible event configuration in accordance with one or more aspects of the present disclosure. The operations of the method 1600 may be implemented by a network entity or its components as described herein. For example, the operations of the method 1600 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1605, the method may include receiving a capability information message indicating that a UE is capable of reading an indication of at least one dynamically configured event, detecting whether conditions corresponding to the at least one dynamically configured event are satisfied, or both. The operations of 1605 may be performed in accordance with examples as disclosed herein. In some examples, aspects of the operations of 1605 may be performed by a capability information manager 1025 as described with reference to FIG. 10.

At 1610, the method may include transmitting a radio resource control message including a list of dynamically configured events, each dynamically configured event corresponding to a set of multiple parameters, where each dynamically configured event is based on the capability information message. The operations of 1610 may be performed in accordance with examples as disclosed herein. In some examples, aspects of the operations of 1610 may be performed by an event list manager 1030 as described with reference to FIG. 10.

At 1615, the method may include transmitting a control message indicating one or more parameters for reporting an occurrence of at least a first event of the list of dynamically configured events. The operations of 1615 may be performed in accordance with examples as disclosed herein. In some examples, aspects of the operations of 1615 may be performed by a report configuration manager 1035 as described with reference to FIG. 10.

At 1620, the method may include receiving a report message indicating the occurrence of the first event associated with one or more conditions corresponding to the first event being satisfied. The operations of 1620 may be performed in accordance with examples as disclosed herein. In some examples, aspects of the operations of 1620 may be performed by a report manager 1040 as described with reference to FIG. 10.

The following provides an overview of aspects of the present disclosure:
Aspect 1: A method for wireless communications at a UE, comprising: transmitting a capability information message indicating that the UE is capable of reading an indication of at least one dynamically configured event, detecting whether conditions corresponding to the at least one dynamically configured event are satisfied, or both; receiving a radio resource control message comprising a list of dynamically configured events, each dynamically configured event corresponding to a plurality of parameters, wherein each dynamically configured event is based at least in part on the capability information message; receiving a control message indicating one or more parameters for reporting an occurrence of at least a first event of the list of dynamically configured events; and transmitting a report message indicating the occurrence of the first event based at least in part on detecting that one or more conditions corresponding to the first event are satisfied.
Aspect 2: The method of aspect 1, wherein the capability information message comprises an indication of a threshold quantity of events of the list of dynamically configured events, a set of combinations of a plurality of conditions the UE is capable of monitoring, a threshold quantity of information in the list of dynamically configured events, a threshold quantity of conditions corresponding to each event of the list of dynamically configured events, a dependency depth for each event of the list of dynamically configured events, or any combination thereof.
Aspect 3: The method of any of aspects 1 through 2, wherein detecting that one or more conditions corresponding to the first event are satisfied comprises: performing one or more measurements on one or more received signals; and determining that the one or more measurements satisfy the one or more conditions.
Aspect 4: The method of aspect 3, wherein the one or more parameters corresponding to the first event comprises an identifier of the one or more received signals, a frequency occupancy of the one or more received signals, a channel identifier corresponding to the one or more parameters, a time stamp corresponding to the one or more received signals, a measurement quantity corresponding to the one or more measurements, a time duration corresponding to the one or more measurements, a measurement identifier corresponding to the one or more measurements, or any combination thereof.
Aspect 5: The method of any of aspects 1 through 4, wherein detecting that one or more conditions corresponding to the first event are satisfied comprises: determining that a location, speed, direction, device type, or cell identifier satisfy the one or more conditions; and performing one or more measurements on one or more received signals based at least in part on the one or more conditions being satisfied.
Aspect 6: The method of aspect 5, wherein the one or more parameters corresponding to the first event comprises an index value corresponding to the one or more parameters, each index value of a set of index values comprising the first event corresponds to a respective candidate set of parameters.
Aspect 7: The method of any of aspects 1 through 6, wherein detecting that one or more conditions corresponding to the first event are satisfied comprises: detecting that a state variable has changed, the state variable comprising expiration of a timer, a counter value satisfying a threshold, a connection state, a location of the UE, or any combination thereof.
Aspect 8: The method of any of aspects 1 through 7, wherein the plurality of parameters corresponding to the first event comprises a range of values defined by a set of measurements, a set of operators, a table, or a combination thereof, detecting that the one or more conditions are satisfied comprises determining that a measured value or detected state falls within the range of values.
Aspect 9: The method of any of aspects 1 through 8, wherein the plurality of parameters corresponding to the first event comprises a subset of values of a vector, detecting that the one or more conditions are satisfied comprises determining that a set of measured values or detected states are defined within the subset of values.
Aspect 10: A method for wireless communications at a network entity, comprising: receiving a capability information message indicating that a UE is capable of reading an indication of at least one dynamically configured event, detecting whether conditions corresponding to the at least one dynamically configured event are satisfied, or both; transmitting a radio resource control message comprising a list of dynamically configured events, each dynamically configured event corresponding to a plurality of parameters, wherein each dynamically configured event is based at least in part on the capability information message; transmitting a control message indicating one or more parameters for reporting an occurrence of at least a first event of the list of dynamically configured events; and receiving a report message indicating the occurrence of the first event associated with one or more conditions corresponding to the first event being satisfied.
Aspect 11: The method of aspect 10, wherein the capability information message comprises an indication of a threshold quantity of events of the list of dynamically configured events, a set of combinations of a plurality of conditions the UE is capable of monitoring, a threshold quantity of information in the list of dynamically configured events, a threshold quantity of conditions corresponding to each event of the list of dynamically configured events, a dependency depth for each event of the list of dynamically configured events, or any combination thereof.
Aspect 12: The method of any of aspects 10 through 11, wherein the one or more parameters corresponding to the first event comprises an identifier of the one or more received signals, a frequency occupancy of the one or more received signals, a channel identifier corresponding to the one or more parameters, a time stamp corresponding to the one or more received signals, a measurement quantity corresponding to the one or more measurements, a time duration corresponding to the one or more measurements, a measurement identifier corresponding to the one or more measurements, or any combination thereof.
Aspect 13: The method of any of aspects 10 through 12, wherein the one or more parameters corresponding to the first event comprises an index value corresponding to the one or more parameters, each index value of a set of index values comprising the first event corresponds to a respective candidate set of parameters.
Aspect 14: The method of any of aspects 10 through 13, wherein the plurality of parameters corresponding to the first event comprises a range of values defined by a set of measurements, a set of operators, a table, or a combination thereof, detecting that the one or more conditions are satisfied comprises determining that a measured value or detected state falls within the range of values.
Aspect 15: The method of any of aspects 10 through 14, wherein the plurality of parameters corresponding to the first event comprises a subset of values of a vector, detecting that the one or more conditions are satisfied comprises determining that a set of measured values or detected states are defined within the subset of values.
Aspect 16: A UE for wireless communications, comprising one or more memories storing processor-executable code, and one or more processors coupled with the one or more memories and individually or collectively operable to execute the code to cause the UE to perform a method of any of aspects 1 through 9.
Aspect 17: A UE for wireless communications, comprising at least one means for performing a method of any of aspects 1 through 9.
Aspect 18: A non-transitory computer-readable medium storing code for wireless communications, the code comprising instructions executable by one or more processors to perform a method of any of aspects 1 through 9.
Aspect 19: A network entity for wireless communications, comprising one or more memories storing processor-executable code, and one or more processors coupled with the one or more memories and individually or collectively operable to execute the code to cause the network entity to perform a method of any of aspects 10 through 15.
Aspect 20: A network entity for wireless communications, comprising at least one means for performing a method of any of aspects 10 through 15.
Aspect 21: A non-transitory computer-readable medium storing code for wireless communications, the code comprising instructions executable by one or more processors to perform a method of any of aspects 10 through 15.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit a capability information message indicating that the UE is capable of reading an indication of at least one dynamically configured event, detecting whether conditions corresponding to the at least one dynamically configured event are satisfied, or both;
receive a radio resource control message comprising a list of dynamically configured events, each dynamically configured event corresponding to a plurality of parameters, wherein each dynamically configured event is based at least in part on the capability information message;
receive a control message indicating one or more parameters for reporting an occurrence of at least a first event of the list of dynamically configured events; and
transmit a report message indicating the occurrence of the first event based at least in part on detecting that one or more conditions corresponding to the first event are satisfied.

2. The UE of claim 1, wherein the capability information message comprises an indication of a threshold quantity of events of the list of dynamically configured events, a set of combinations of a plurality of conditions the UE is capable of monitoring, a threshold quantity of information in the list of dynamically configured events, a threshold quantity of conditions corresponding to each event of the list of dynamically configured events, a dependency depth for each event of the list of dynamically configured events, or any combination thereof.

3. The UE of claim 1, wherein, to detect that one or more conditions corresponding to the first event are satisfied, the one or more processors are individually or collectively operable to execute the code to cause the UE to:
perform one or more measurements on one or more received signals; and
determine that the one or more measurements satisfy the one or more conditions.

4. The UE of claim 3, wherein the one or more parameters corresponding to the first event comprises an identifier of the one or more received signals, a frequency occupancy of the one or more received signals, a channel identifier corresponding to the one or more parameters, a time stamp corresponding to the one or more received signals, a measurement quantity corresponding to the one or more measurements, a time duration corresponding to the one or more measurements, a measurement identifier corresponding to the one or more measurements, or any combination thereof.

5. The UE of claim 1, wherein, to detect that one or more conditions corresponding to the first event are satisfied, the one or more processors are individually or collectively operable to execute the code to cause the UE to:
determine that a location, speed, direction, device type, or cell identifier satisfy the one or more conditions; and
perform one or more measurements on one or more received signals based at least in part on the one or more conditions being satisfied.

6. The UE of claim 5, wherein the one or more parameters corresponding to the first event comprises an index value corresponding to the one or more parameters, each index value of a set of index values comprising the first event corresponds to a respective candidate set of parameters.

7. The UE of claim 1, wherein, to detect that one or more conditions corresponding to the first event are satisfied, the one or more processors are individually or collectively operable to execute the code to cause the UE to:
detect that a state variable has changed, the state variable comprising expiration of a timer, a counter value satisfying a threshold, a connection state, a location of the UE, or any combination thereof.

8. The UE of claim 1, wherein the plurality of parameters corresponding to the first event comprises a range of values defined by a set of measurements, a set of operators, a table, or a combination thereof, and wherein detecting that the one or more conditions are satisfied comprises determining that a measured value or detected state falls within the range of values.

9. The UE of claim 1, wherein the plurality of parameters corresponding to the first event comprises a subset of values of a vector, and wherein detecting that the one or more conditions are satisfied comprises determining that a set of measured values or detected states are defined within the subset of values.

10. A network entity, comprising:
one or more memories storing processor-executable code; and
one or more processors coupled with the one or more memories and individually or collectively operable to execute the code to cause the network entity to:
receive a capability information message indicating that a user equipment (UE) is capable of reading an indication of at least one dynamically configured event, detecting whether conditions corresponding to the at least one dynamically configured event are satisfied, or both;
transmit a radio resource control message comprising a list of dynamically configured events, each dynamically configured event corresponding to a plurality of parameters, wherein each dynamically configured event is based at least in part on the capability information message;
transmit a control message indicating one or more parameters for reporting an occurrence of at least a first event of the list of dynamically configured events; and
receive a report message indicating the occurrence of the first event associated with one or more conditions corresponding to the first event being satisfied.

11. The network entity of claim 10, wherein the capability information message comprises an indication of a threshold quantity of events of the list of dynamically configured events, a set of combinations of a plurality of conditions the UE is capable of monitoring, a threshold quantity of information in the list of dynamically configured events, a threshold quantity of conditions corresponding to each event of the list of dynamically configured events, a dependency depth for each event of the list of dynamically configured events, or any combination thereof.

12. The network entity of claim 10, wherein the one or more parameters corresponding to the first event comprises an identifier of one or more received signals, a frequency occupancy of the one or more received signals, a channel identifier corresponding to the one or more parameters, a time stamp corresponding to the one or more received signals, a measurement quantity corresponding to one or more measurements, a time duration corresponding to the one or more measurements, a measurement identifier corresponding to the one or more measurements, or any combination thereof.

13. The network entity of claim 10, wherein the one or more parameters corresponding to the first event comprises an index value corresponding to the one or more parameters, each index value of a set of index values comprising the first event corresponds to a respective candidate set of parameters.

14. The network entity of claim 10, wherein the plurality of parameters corresponding to the first event comprises a range of values defined by a set of measurements, a set of operators, a table, or a combination thereof, and wherein detecting that the one or more conditions are satisfied comprises determining that a measured value or detected state falls within the range of values.

15. The network entity of claim 10, wherein the plurality of parameters corresponding to the first event comprises a subset of values of a vector, and wherein detecting that the one or more conditions are satisfied comprises determining that a set of measured values or detected states are defined within the subset of values.

16. A network entity, comprising:
a processing system that includes processor circuitry and memory circuitry that stores code, the processing system configured to cause the network entity to:
receive a capability information message indicating that a user equipment (UE) is capable of reading an indication of at least one dynamically configured event, detecting whether conditions corresponding to the at least one dynamically configured event are satisfied, or both;
transmit a radio resource control message comprising a list of dynamically configured events, each dynamically configured event corresponding to a plurality of parameters, wherein each dynamically configured event is based at least in part on the capability information message;
transmit a control message indicating one or more parameters for reporting an occurrence of at least a first event of the list of dynamically configured events; and
receive a report message indicating the occurrence of the first event associated with one or more conditions corresponding to the first event being satisfied.

17. The network entity of claim 16, wherein the capability information message comprises an indication of a threshold quantity of events of the list of dynamically configured events, a set of combinations of a plurality of conditions the UE is capable of monitoring, a threshold quantity of information in the list of dynamically configured events, a threshold quantity of conditions corresponding to each event of the list of dynamically configured events, a dependency depth for each event of the list of dynamically configured events, or any combination thereof.

18. The network entity of claim 16, wherein the one or more parameters corresponding to the first event comprises an identifier of one or more received signals, a frequency occupancy of the one or more received signals, a channel identifier corresponding to the one or more parameters, a time stamp corresponding to the one or more received signals, a measurement quantity corresponding to one or more measurements, a time duration corresponding to the one or more measurements, a measurement identifier corresponding to the one or more measurements, or any combination thereof.

19. The network entity of claim 16, wherein the one or more parameters corresponding to the first event comprises an index value corresponding to the one or more parameters, each index value of a set of index values comprising the first event corresponds to a respective candidate set of parameters.

20. The network entity of claim 16, wherein the plurality of parameters corresponding to the first event comprises a range of values defined by a set of measurements, a set of operators, a table, or a combination thereof, and wherein detecting that the one or more conditions are satisfied comprises determining that a measured value or detected state falls within the range of values.

21. The network entity of claim 16, wherein the plurality of parameters corresponding to the first event comprises a subset of values of a vector, and wherein detecting that the one or more conditions are satisfied comprises determining that a set of measured values or detected states are defined within the subset of values.

22. A method for wireless communications at a user equipment (UE), comprising:
transmitting a capability information message indicating that the UE is capable of reading an indication of at least one dynamically configured event, detecting whether conditions corresponding to the at least one dynamically configured event are satisfied, or both;
receiving a radio resource control message comprising a list of dynamically configured events, each dynamically configured event corresponding to a plurality of parameters, wherein each dynamically configured event is based at least in part on the capability information message;
receiving a control message indicating one or more parameters for reporting an occurrence of at least a first event of the list of dynamically configured events; and
transmitting a report message indicating the occurrence of the first event based at least in part on detecting that one or more conditions corresponding to the first event are satisfied.

23. The method of claim 22, wherein the capability information message comprises an indication of a threshold quantity of events of the list of dynamically configured events, a set of combinations of a plurality of conditions the UE is capable of monitoring, a threshold quantity of information in the list of dynamically configured events, a threshold quantity of conditions corresponding to each event of the list of dynamically configured events, a dependency depth for each event of the list of dynamically configured events, or any combination thereof.

24. The method of claim 22, wherein detecting that one or more conditions corresponding to the first event are satisfied comprises:
performing one or more measurements on one or more received signals; and
determining that the one or more measurements satisfy the one or more conditions.

25. The method of claim 24, wherein the one or more parameters corresponding to the first event comprises an identifier of the one or more received signals, a frequency occupancy of the one or more received signals, a channel identifier corresponding to the one or more parameters, a time stamp corresponding to the one or more received signals, a measurement quantity corresponding to the one or more measurements, a time duration corresponding to the one or more measurements, a measurement identifier corresponding to the one or more measurements, or any combination thereof.

26. The method of claim 22, wherein detecting that one or more conditions corresponding to the first event are satisfied comprises:
determining that a location, speed, direction, device type, or cell identifier satisfy the one or more conditions; and
performing one or more measurements on one or more received signals based at least in part on the one or more conditions being satisfied.

27. The method of claim 26, wherein the one or more parameters corresponding to the first event comprises an index value corresponding to the one or more parameters, each index value of a set of index values comprising the first event corresponds to a respective candidate set of parameters.

28. The method of claim 22, wherein detecting that one or more conditions corresponding to the first event are satisfied comprises:
detecting that a state variable has changed, the state variable comprising expiration of a timer, a counter value satisfying a threshold, a connection state, a location of the UE, or any combination thereof.

29. The method of claim 22, wherein the plurality of parameters corresponding to the first event comprises a range of values defined by a set of measurements, a set of operators, a table, or a combination thereof, and wherein detecting that the one or more conditions are satisfied comprises determining that a measured value or detected state falls within the range of values.

30. The method of claim 22, wherein the plurality of parameters corresponding to the first event comprises a subset of values of a vector, and wherein detecting that the one or more conditions are satisfied comprises determining that a set of measured values or detected states are defined within the subset of values.
